(19) United States
(12) Patent Application Publication
(10) Pub. No.: US 2026/0342591 A1
(43) Pub. Date: Oct. 29, 2026

(54) METHOD AND APPARATUS FOR POST-QUANTUM CRYPTOGRAPHY COMMUNICATION

(71) Applicant: HUAWEI TECHNOLOGIES CO., LTD., Shenzhen (CN)

(72) Inventors: Chitra Javali, Singapore (SG); Zhongding Lei, Singapore (SG); Fei Liu, Singapore (SG)

(73) Assignee: HUAWEI TECHNOLOGIES CO., LTD., Shenzhen (CN)

(21) Appl. No.: 19/714,581

(22) Filed: Jun. 21, 2026

Related U.S. Application Data
(63) Continuation of application No. PCT/CN2023/140305, filed on Dec. 20, 2023.

(51) Int. Cl. H04L 9/32; H04L 9/08

(52) U.S. Cl. CPC H04L 9/3247; H04L 9/0852

(57) ABSTRACT

In the present disclosure, a method and an apparatus for post-quantum cryptography communication are presented. The method includes generating a first message, where the first message includes credential identification information that identifies credential information; and sending the first message. In the present application, credential identification information which is used to identify credential information (e.g. certificates or public keys) is transmitted in place of the entire certificate and public key, hence which reduces the size of the message transmitted and also ensures security.

### CROSS-REFERENCE TO RELATED APPLICATIONS

This application is a continuation of International Application No. PCT/CN2023/140305, filed on Dec. 20, 2023, the disclosure of which is hereby incorporated by reference in its entirety.

### TECHNICAL FIELD

The present disclosure relates to the field of communication technologies, and in particular, to a method and an apparatus for post-quantum cryptography communication.

### BACKGROUND

Cellular vehicle to everything (V2X) (C-V2X) is the merging of vehicular communication and mobile systems. C-V2X is a 3GPP standard for V2X applications. In 5G, C-V2X services by the 3GPP support safety and non-safety messages/applications. Vehicle to vehicle (V2V) communication uses a PC5 interface i.e., any direct link between the vehicles to any other entity employs PC5. The PC5 interface is also used by vehicles to broadcast safety messages.

The IEEE 1609.2 and 1609.2.1 standards for connected vehicle (CV) security describe the protocols that are required for authenticating messages broadcast by vehicles, including V2V certificates. Currently, these standards employ traditional cryptographic algorithms i.e., elliptic curve cryptography (ECC), and particularly on the Elliptic Curve Digital Signature Algorithm (ECDSA) for signing V2V messages. The ECDSA uses either the National Institute of Standards and Technology (NIST) P-256 or a brainpoolP256r1 elliptic curve, both of which are well-established curves used in cryptographic applications.

This background information is provided to reveal information believed by the applicant to be of possible relevance to the present disclosure. No admission is necessarily intended, nor should be construed, that any of the preceding information constitutes prior art against the present disclosure.

### SUMMARY

In a first aspect, the present disclosure provides a communication method, including: generating a first message, where the first message includes credential identification information that identifies credential information; and sending the first message.

Since the first message includes the credential identification information that identifies credential information, the credential information can be obtained through the credential identification information when needed for verification of the first message, and the first message may not need to include the credential information, thereby decreasing the message transfer of credential information while ensuring the security of communication.

In an example implementation of the first aspect, the credential information includes at least one credential. Therefore, one or more credentials may be obtained through the credential identification information and then used for verification of the message, which increases the flexibility of the solution while decreasing the message transfer of credential information.

In an example implementation of the first aspect, each of the at least one credential includes a certificate, where the certificate includes a public key. Since each credential may include a certificate, the certificate may be verified to authenticate the sender of the first message. The public key may be extracted from the certificate, and then be used for verification of the message.

In an example implementation of the first aspect, the credential identification information includes a pointer or a uniform resource locator (URL) to the credential information. In this way, the first message may carry a pointer or a URL to the credential information, through which the credential information can be obtained, and the first message may not need to include the credential information, and thus the message transfer of credential information could be decreased.

In an example implementation of the first aspect, the first message includes a signed message and a second message, and the signed message includes one or more signatures on the second message, where the second message includes the credential identification information. Since the credential identification information is included in the second message, and the first message includes a signed message and the second message, and the signed message includes one or more signatures on the second message, the content of the second message, which includes the credential identification information, could be integrity protected, thereby ensuring the security of communication.

In an example implementation of the first aspect, the second message further includes a basic safety message (BSM). Since the second message may include a BSM along with the credential identification information, the sender of the message may be authenticated through verifying the credential information which may be obtained through the credential identification information included in the second message, and since the first message includes a signed message and the second message, and the signed message includes the signature(s) on the second message, the content of the BSM could be integrity protected. Thus, the authenticity of the BSM and trustworthiness of the message sender could be ensured, and meanwhile the message transfer of credential information could be decreased.

In an example implementation of the first aspect, the one or more signatures on the second message are obtained by using one or more signature algorithms with one or more private keys. In an example implementation of the first aspect, generating the first message includes: generating the second message including the credential identification information; and signing the second message with the one or more private keys by using the one or more signature algorithms. One or more signature algorithms may be used for obtaining the signature(s). In addition, the second message may be signed with one or more private keys by using one or more signature algorithms. The signature algorithm(s) may be selected according to actual demands, which could increase the flexibility of the solution.

In an example implementation of the first aspect, the one or more signature algorithms respectively correspond to one or more credentials. When a signature algorithm is used, a corresponding credential may be used for the verification of the message, which provides more choices for the verification.

In an example implementation of the first aspect, the one or more signature algorithms includes at least one of: at least one first signature algorithm, or at least one second signature algorithm. In an example implementation of the first aspect, the one or more signatures include at least one of: at least one first signature obtained by using the at least one first signature algorithm, or at least one second signature obtained by using at least one second signature algorithm. The at least one first signature algorithm, or the at least one second signature algorithm, or both of them may be used, and correspondingly the first message may include at least one first signature obtained by using at least one first signature algorithm, at least one second signature obtained by using at least one second signature algorithm or both of the first and second signatures. In this way, different numbers or different kinds of signature algorithms may be used according to actual demands, which could increase the flexibility of the solution.

In an example implementation of the first aspect, the one or more signatures include a first signature and a second signature, and the at least one credential includes a first credential corresponding to a first signature algorithm used to obtain the first signature and a second credential corresponding to a second signature algorithm used to obtain the second signature. Since both the first signature and the second signature are included in the first message, security of communication could be enhanced. Meanwhile, since the first message includes two signatures obtained by using two signature algorithms, the verification may still be conducted even if the receiver supports only one of the signature algorithms, which could increase the compatibility of the solution. In addition, since the credentials corresponding to the first and second signatures algorithms are included in the at least one credential, the credentials for the first and second signatures may be obtained through the credential identification information, and the first message needs not to carry the first and second credentials, and thus the message transfer of credential information could be decreased.

In an example implementation of the first aspect, the one or more signatures include a first signature and a second signature, the first message further includes a first credential corresponding to a first signature algorithm used to obtain the first signature, and the at least one credential includes a second credential corresponding to a second signature algorithm used to obtain the second signature. Since the first message includes both the first signature and the second signature, the security of communication and the compatibility of the solution could be improved. In addition, since the first message includes the first credential for the first signature algorithm, verification may be conducted based on the first credential and the first signature in a traditional way, which could make the solution backwards compatible. Moreover, since the second credential is not included in the first message but can be obtained through the credential identification information, the message transfer of the second credential could be decreased.

In an example implementation of the first aspect, the one or more signatures include a first signature, and the at least one credential includes a first credential corresponding to a first signature algorithm used to obtain the first signature; or the one or more signatures include one or more second signatures, and the at least one credential includes one or more second credentials corresponding to one or more second signature algorithms used to obtain the one or more second signatures. The first message may include either the first signature or the second signature, and the signature algorithm used may be selected according to actual demands. The credential may be obtained through the credential identification information, thereby decreasing the message transfer of the credential information.

In an example implementation of the first aspect, the first signature algorithm is a non-post-quantum cryptography (non-PQC) algorithm. When a non-PQC algorithm is used, the solution could be backwards compatible so that the devices that follow traditional cryptography may also adapt to the solution.

In an example implementation of the first aspect, the second signature algorithm is a post-quantum cryptography (PQC) algorithm. When a PQC algorithm is used, security of communication could be greatly enhanced, since PQC algorithms are considered quantum-safe. Further, since the credential information may be obtained through the credential identification information, the credential for the PQC algorithm, which is usually large in size, needs not to be included in the message, the message transfer of the credential for the PQC algorithm could be greatly decreased, and the over the air spectrum efficiency could be significantly improved.

In an example implementation of the first aspect, the method further includes: obtaining the at least one credential. The at least one credential may be obtained in advance, for example, from a certificate authority.

In an example implementation of the first aspect, the method further includes performing registration to obtain the credential identification information. The credential information may be registered to a server in advance to obtain the credential identification information that identifies credential information.

In an example implementation of the first aspect, performing registration to obtain the credential identification information includes: sending the credential information; and obtaining the credential identification information. The credential information may be sent to the server so that the server can store the credential information and generate the credential identification information. Then, the credential identification information can be obtained from the server, and be included in the first message so that the receiver can obtain the credential information through the credential identification information.

In an example implementation of the first aspect, the first message is sent in a broadcast mode. The first message may be a message broadcast by a device to other devices, and then the other devices receiving the message can obtain the credential information of the transmitting device through the credential identification information included in the first message, thereby decreasing the message transfer of the credential information during broadcast.

In a second aspect, the present disclosure provides a communication method, including:
obtaining a first message, where the first message includes credential identification information that identifies credential information;
obtaining the credential information according to the credential identification information;
obtaining one or more credentials, where at least one of the one or more credentials is obtained from the credential information; and
verifying the first message according to the one or more credential.

Since the first message includes the credential identification information that identifies credential information, the credential information can be obtained through the credential identification information. In addition, since at least one credential to be used for verification can be obtained from the credential information, the first message needs not carry all the credential(s) needed for verification, thereby decreasing the message transfer of credential information while ensuring the security of communication.

In an example implementation of the second aspect, the credential identification information includes a pointer or a URL to the credential information. In this way, the credential information can be obtained through the pointer or URL to the credential information, and the first message may not need to include the credential information, and thus the message transfer of credential information could be decreased.

In an example implementation of the second aspect, obtaining the credential information according to the credential identification includes: obtaining the credential identification information according to the credential identification from a server. The credential information may be stored in a server, and after the credential identification information is obtained, the credential information may be obtained through the credential identification information from the server.

In an example implementation of the second aspect, obtaining the credential identification information according to the credential identification from a server includes: sending the credential identification information to the server; and receiving the credential information identified by the credential identification information from the server. The credential identification information may be sent to the server so that the server can identify the credential information according to the credential identification information and send back the credential information, and then the credential information can be obtained.

In an example implementation of the second aspect, the method further includes: storing the credential information identified by the credential identification information locally. After obtaining the credential information, it can be stored locally for further use, thereby reducing transmission of the credential information.

In an example implementation of the second aspect, the credential identification information is obtained according to the credential identification from a server in a case that the credential identification information is not stored locally. When the credential information has been stored, it can be obtained based on the credential identification information from storage, and the credential identification information needs not to be sent to the server for obtaining the credential information. When the credential information is not stored, the credential identification information can be sent to the server to obtain the credential information. In this way, transmission between the message receiver and the server for obtaining the credential information could be reduced and transmission resources could be saved.

In an example implementation of the second aspect, the first message includes a signed message and a second message, and the signed message includes one or more signatures on the second message, where the second message includes the credential identification information.

Since the credential identification information is included in the second message, and the first message includes a signed message and the second message, and the signed message includes one or more signatures on the second message, the content of the second message, which includes the credential identification information, could be integrity protected, thereby ensuring the security of communication.

In an example implementation of the second aspect, the second message further includes a BSM. Since the second message may include a BSM along with the credential identification information, the sender of the message can be authenticated through verifying the credential information, which can be obtained through the credential identification information included in the second message, and since the first message includes the signed message and the second message, the signed message includes the signature(s) on the second message, the content of the BSM can be integrity protected. Thus, the authenticity of the BSM and trustworthiness of the message sender can be ensured, and meanwhile the message transfer of credential information can be decreased.

In an example implementation of the second aspect, the one or more signatures are obtained by using one or more signature algorithms, and each of the one or more signatures is obtained by using one of one or more signature algorithms. One or more signature algorithms may be used for obtaining the signature(s). The signature algorithm(s) may be selected according to actual demands, which could increase the flexibility of the solution.

In an example implementation of the second aspect, the one or more credentials respectively correspond to the one or more signature algorithms. When a signature algorithm is used, a corresponding credential may be used for the verification of the message, which provides more choices for the verification.

In an example implementation of the second aspect, the one or more signatures include at least one of: at least one first signature obtained by using at least one first signature algorithm, or at least one second signature obtained by using at least one second signature algorithm. The first message may include at least one first signature obtained by using at least one first signature algorithm, or at least one second signature obtained by using at least one second signature algorithm, or both of the first and second signatures. In this way, different numbers or different kinds of signature algorithms may be used according to actual demands, which could increase the flexibility of solution.

In an example implementation of the second aspect, obtaining one or more credentials includes: obtaining the one or more credentials from the credential information. The one or more credentials may all be obtained from the credential information, and the first message needs not to carry the one or more credentials, thereby decreasing the message transfer of the credential(s).

In an example implementation of the second aspect, the one or more signatures include a first signature and a second signature, and the first message further includes a first credential corresponding to a first signature algorithm used to obtain the first signature, and obtaining one or more credentials includes: obtaining the first credential from the first message; and obtaining a second credential corresponding to a second signature algorithm used to obtain the second signature from the credential information. Since both the first signature and the second signature are included in the first message, security of communication could be enhanced. Meanwhile, since the first message includes two signatures obtained by using two signature algorithms, the verification may still be conducted even if the receiver supports only one of the signature algorithms, thereby increasing the compatibility of the solution. In addition, since the first message includes the first credential for the first signature algorithm, verification may be conducted based on the first credential and the first signature in a traditional way, which makes the solution backwards compatible. Moreover, since the second credential is not included in the first message but can be obtained through the credential identification information, the message transfer of the credential information could be decreased.

In an example implementation of the second aspect, verifying the first message according to the one or more credentials includes: verifying, according to the one or more credentials, legitimacy of the second message by using the one or more signature algorithms. The legitimacy of the second message may be verified using one or more signature algorithms based on one or more corresponding credentials, which may enhance security of communication and improve flexibility of the solution.

In an example implementation of the second aspect, the one or more credentials include one or more public keys respectively corresponding to the one or more signature algorithms, and verifying, according to the one or more credentials, legitimacy of the second message by using the one or more signature algorithms includes: verifying the one or more signatures by using the one or more signature algorithm with the one or more public keys. Each signature may be verified by using a corresponding signature algorithm with a public key obtained from a corresponding credential, thereby verifying the legitimacy of the second message.

In an example implementation of the second aspect, the one or more credential includes one or more certificate respectively corresponding to the one or more signature algorithms, and the method further includes: verifying the one or more certificates. The certificate(s) included in the credential(s) may be verified to authenticate the sender of the message, thereby ensuring the security of the communication.

In an example implementation of the second aspect, the first signature algorithm is a non-PQC algorithm. When a non-PQC algorithm is used, the solution could be backwards compatible so that the devices that follow traditional cryptography may also adapt to the solution.

In an example implementation of the second aspect, the second signature algorithm is a PQC algorithm. When a PQC algorithm is used, security of communication could be greatly enhanced, since PQC algorithms are quantum-safe. Further, since the credential information may be obtained through the credential identification information, the credential for the PQC algorithm, which is usually large in size, needs not to be included in the message, and thus, the message transfer of the credential for the PQC algorithm could be greatly decreased, and the over the air spectrum efficiency could be significantly improved.

In an example implementation of the second aspect, the first message is a broadcast message. The first message may be a message broadcast by a device to other devices, and then the other devices receiving the message can obtain the credential information of the transmitting device through the credential identification information included in the first message, thereby decreasing the message transfer of the credential information during broadcast.

In a third aspect, the present disclosure provides a communication method, including: receiving, from second user equipment (UE), credential identification information, where the credential identification information identifies credential information of first UE; and sending, to the second UE, the credential information of the first UE identified by the credential identification information.

Since the credential identification information of the first UE can be received from the second UE, and the credential information of the first UE, which is identified by the credential identification information of the first UE, can be sent to the second UE, the credential information can be obtained through the credential identification information, and thus, messages sent from the first UE to the second UE may not need to carry the credential information of the first UE, which could decrease the message transfer of credential information while ensuring the security of communication.

In an example implementation of the third aspect, the credential information of the first UE includes at least one credential of the first UE. Therefore, one or more credentials may be obtained through the credential identification information, which increases the flexibility of the solution.

In an example implementation of the third aspect, each of the at least one credential includes a certificate, where the certificate includes a public key. Since each credential may include a certificate, the certificate may be verified to authenticate the first UE. The public key may be extracted from the certificate, and then be used for verification of the messages sent from the first UE.

In an example implementation of the third aspect, the method further includes: performing registration for the first UE. The credential information of the first UE may be registered in advance so that the first UE can get the credential identification information that identifies credential information.

In an example implementation of the third aspect, performing the registration for the first UE includes: receiving the credential information of the first UE; storing the credential information of the first UE, and generating the credential identification information that identifies the credential information of the first UE; and sending the credential identification information. The credential information of the first UE may be received and stored, and the credential identification information that identifies the credential information may be generated and sent back. In this way, the credential information of the first UE can be registered, and the first UE can get the credential identification information and include the same in messages sent to other UE so that other UE can obtain the credential information through the credential identification information.

In an example implementation of the third aspect, the at least one credential corresponds to at least one signature algorithm respectively. One or more credentials may be registered, where each credential corresponds to a signature algorithm and can be used for the verification of messages signed using that signature algorithm, which could increase the flexibility of the solution.

In an example implementation of the third aspect, the credential information includes at least one of: at least one first credential corresponding to at least one first signature algorithm, or at least one second credential corresponding to at least one second signature algorithm. The credential information may include different numbers of credentials for different signature algorithms, which could increase the flexibility of the solution

In an example implementation of the third aspect, the first signature algorithm is a non-PQC algorithm. When a non-PQC algorithm is used, the solution could be backwards compatible so that the devices that follow traditional cryptography may also adapt to the solution.

In an example implementation of the third aspect, the second signature algorithm is a PQC algorithm. When a PQC algorithm is used, communication security between the first UE and the second could be greatly enhanced, since PQC algorithms are quantum-safe. Further, since the credential information may be obtained through the credential identification information, the credential for the PQC algorithm, which is usually large in size, needs not to be included in the messages transmitted between the first UE and the second UE, the message transfer of the credential for the PQC algorithm could be greatly decreased, and the over the air spectrum efficiency could be significantly improved.

In a fourth aspect, an example implementation of the present disclosure provides a first apparatus, including various modules configured to execute the communication method according to the first aspect or any possible implementation of the first aspect.

In a fifth aspect, an example implementation of the present disclosure provides a second apparatus, including various modules configured to execute the communication method according to the second aspect or any possible implementation of the second aspect.

In a sixth aspect, an example implementation of the present disclosure provides a third apparatus, including various modules configured to execute the communication method according to the third aspect or any possible implementation of the second aspect.

In a seventh aspect, an example implementation of the present disclosure provides a fourth apparatus, including a processing circuitry for executing the communication method according to the first aspect or any possible implementation of the first aspect.

In an eighth aspect, an example implementation of the present disclosure provides a fifth apparatus, including a processing circuitry for executing the communication method according to the second aspect or any possible implementation of the second aspect.

In a ninth aspect, an example implementation of the present disclosure provides a sixth apparatus, including a processing circuitry for executing the communication method according to the third aspect or any possible implementation of the second aspect.

In a tenth aspect, an example implementation of the present disclosure provides a communication management system, including: a first apparatus according to the fourth aspect or a fourth apparatus according to the seventh aspect; a second apparatus according to the fifth aspect or a fifth apparatus according to the eighth aspect; and a third apparatus according to the sixth aspect or a sixth apparatus according to the ninth aspect.

In a twelfth aspect, an example implementation of the present disclosure provides a communication system, including: a first processing circuitry for executing the communication method according to the first aspect or any possible implementation of the first aspect; a second processing circuitry for executing the communication method according to the second aspect or any possible implementation of the second aspect; and a third processing circuitry for executing the communication method according to the third aspect or any possible implementation of the third aspect.

In a thirteenth aspect, an example implementation of the present disclosure provides a computer-readable storage medium storing computer execution instructions which, when executed by a processor, cause the processor to execute the communication method according to the first aspect or any possible implementation of the first aspect, or the second aspect or any possible implementation of the second aspect, or the third aspect or any possible implementation of the third aspect.

In a fourteenth aspect, an example implementation of the present disclosure provides a computer program product including computer execution instructions which, when executed by a processor, cause the processor to execute the communication method according to the first aspect or any possible implementation of the first aspect or any possible implementation of the first aspect, or the second aspect or any possible implementation of the second aspect, or the third aspect or any possible implementation of the third aspect.

The present disclosure provides a communication method, apparatus, and system. A first message may include credential identification information that identifies the credential information, and the credential information may be obtained through the credential identification information when needed for verification of the first message. The first message may not need to include the credential information, thereby decreasing the message transfer of credential information while ensuring the security of communication.

### BRIEF DESCRIPTION OF DRAWINGS

Reference will now be made, by way of example, to the accompanying drawings which show example embodiments of the present disclosure, and in which:

FIG. 1 is a simplified schematic illustration of a communication system according to one or more embodiments of the present disclosure.

FIG. 2 is a schematic diagram of a basic component structure of an electronic device according to one or more example embodiments of the present disclosure.

FIG. 3 is a schematic diagram of a V2V communication scenario.

FIG. 4 is a schematic diagram of a V2X communication system in the 5G architecture according to one or more example embodiments of the present disclosure.

FIG. 5 shows a schematic flowchart of a communication method according to one or more example embodiments of the present disclosure.

FIG. 6 shows a schematic flowchart of a communication method according to one or more example embodiments of the present disclosure.

FIG. 7 shows a schematic flowchart of a communication method according to one or more example embodiments of the present disclosure.

FIG. 8 is a schematic illustration of communication among devices according to one or more example embodiments of the present disclosure.

FIG. 9 is a schematic illustration of communication among devices according to one or more example embodiments of the present disclosure.

FIG. 10 is a schematic illustration of communication among devices according to one or more example embodiments of the present disclosure.

FIG. 11 is a schematic illustration of a registration scenario according to one or more example embodiments of the present disclosure.

FIG. 12 shows a schematic structural diagram of a first apparatus according to one or more example embodiments of the present disclosure.

FIG. 13 shows a schematic structural diagram of a second apparatus according to one or more example embodiments of the present disclosure.

FIG. 14 shows a schematic structural diagram of a third apparatus according to one or more example embodiments of the present disclosure.

### DESCRIPTION OF EMBODIMENTS

In the following description, reference is made to the accompanying figures, which form part of the present disclosure, and which show, by way of illustration, specific aspects of embodiments of the present disclosure or specific aspects in which embodiments of the present disclosure may be used. It is understood that embodiments of the present disclosure may be used in other aspects and include structural or logical changes not depicted in the figures. The following detailed description, therefore, is not to be taken in a limiting sense, and the scope of the present disclosure is defined by the appended claims.

To assist in understanding the present disclosure, examples of wireless communication systems and devices are described below.

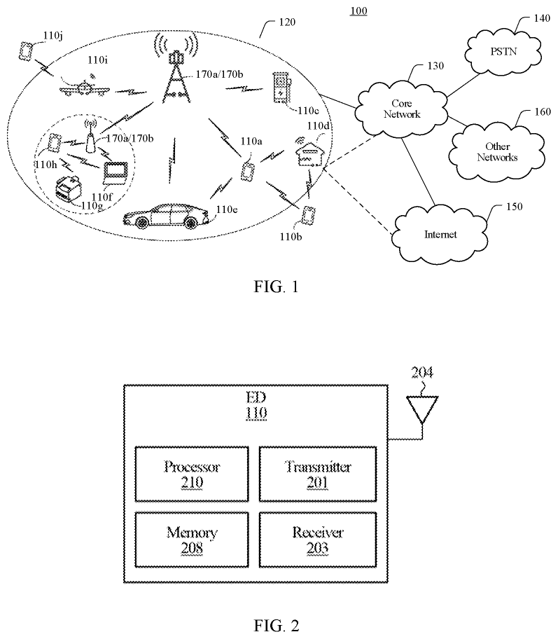

Referring to FIG. 1, as an illustrative example without limitation, a simplified schematic illustration of a communication system is provided. The communication system 100 includes a radio access network 120. The radio access network 120 may be a next generation (e.g., sixth generation (6G) or later) radio access network, or a legacy (e.g., 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 includes a public switched telephone network (PSTN) 140, the internet 150, and other networks 160.

FIG. 2 is a schematic diagram of a basic component structure of an ED 110 according to one or more example embodiments of the present disclosure. Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities.

The ED 110 includes a transmitter 201 and a receiver 203 coupled to one or more antennas. Only one antenna is illustrated. One, some, or all of the antennas may alternatively be panels. The transmitter 201 and the receiver 203 may be integrated, e.g. as a transceiver. The transceiver is configured to modulate data or other content for transmission by at least one antenna or network interface controller (NIC). The transceiver is also configured to demodulate data or other content received by the at least one antenna. Each transceiver includes any suitable structure for generating signals for wireless or wired transmission and/or processing signals received wirelessly or by wire.

Each antenna includes any suitable structure for transmitting and/or receiving wireless or wired signals.

The ED 110 includes at least one memory 208. The memory 208 stores instructions and data used, generated, or collected by the ED 110. For example, the memory could store software instructions or modules configured to implement some or all of the functionality and/or embodiments described herein and that are executed by the processing unit(s). Each memory includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170a or 170b, those related to processing downlink transmissions received from the NT-TRP 172 and/or T-TRP 170a or 170b, and those related to processing sidelink transmission to and from another ED. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170a or 170b. In some embodiments, the processor implements the transmit beamforming and/or receive beamforming based on the indication of beam direction, e.g. beam angle information (BAI), received from T-TRP 170a or 170b. In some embodiments, the processor may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

The processor 210 may form part of the transmitter 201 and/or receiver 203. The memory 208 may form part of the processor 210.

The processor 210, and the processing components of the transmitter 201 and receiver 203 may each be implemented by the same or different one or more processors that are configured to execute instructions stored in a memory (e.g. in memory). Alternatively, some or all of the processor, and the processing components of the transmitter 201 and receiver 203 may be implemented using dedicated circuitry, such as a programmed field-programmable gate array (FPGA), a graphical processing unit (GPU), or an application-specific integrated circuit (ASIC).

Cellular vehicle to everything (V2X) (C-V2X) is the merging of vehicular communication and mobile systems. C-V2X is a 3GPP standard for V2X applications, and is integrated into the 5G network to support both safety-related and non-safety-related applications. V2V communication uses a PC5 interface i.e., any direct link between the vehicles to any other entity employs PC5. The PC5 interface is used by vehicles to broadcast safety messages.

A basic safety message (BSM) is a critical component of V2V communication, and is transmitted on an average 10 messages/sec by a vehicular UE. Each BSM contains motion and position information to allow other vehicles to coordinate their movements to avoid collisions. In order to function safely, robust security mechanisms are needed to ensure the authenticity of received messages and trustworthiness of message senders. Every BSM is signed and packed, along with the security information needed for verification, into a secure protocol data unit (SPDU).

In the 3GPP TS 23.287: architecture enhancements for 5G System (5GS) to support Vehicle-to-Everything (V2X) services-specifies the architecture enhancements to the 5G System to facilitate vehicular communications for Vehicle-to-Everything (V2X) services.

In the 3GPP TS 33.536: security aspects of 3GPP support for advanced Vehicle-to-Everything (V2X) services-specifies the security aspects for the 5G system to facilitate vehicular communications for Vehicle-to-Everything (V2X) services. It has the procedure described for security for unicast mode, however not for broadcast mode.

The IEEE 1609.2 and 1609.2.1 standards for CV security describe the protocols that are required for authenticating messages broadcast by vehicles, including V2V certificates. Currently, these standards employ traditional cryptographic algorithms i.e., elliptic curve cryptography (ECC), and particularly on the Elliptic Curve Digital Signature Algorithm (ECDSA) for signing V2V messages. The ECDSA uses either the National Institute of Standards and Technology (NIST) P-256 or a brainpoolP256r1 elliptic curve, both of which are well-established curves used in cryptographic applications.

The Table 1 lists V2X application cases with the message payload and frequency of messages as from the following TS and TR:
TR 22.885: Study on LTE Support for V2X Services
TR 22.886: Study on enhancement of 3GPP Support for 5G V2X Services
TS 22.185: Service Requirements for V2X Services
TS 22.186: Enhancement of 3GPP Support for V2X Scenarios.

TABLE 1
V2X Use Cases

| Use Case | Message Payload | | Frequency | |
|---|---|---|---|---|
| Forward Collision Warning | 50-300 | Bytes | 10 | messages/s |
| Cooperative Adaptive | 50-300 | Bytes | 1 | messages/s |
| Cruise Control | | | | |
| Control Loss Warning | 50-300 | Bytes | 10 | messages/s |
| Emergency Vehicle Warning | 400 | Bytes | 10 | messages/s |
| Pre-crash Sensing Warning | 50-300 | Bytes | 50 | messages/s |
| Queue Warning | 400 | Bytes | 10 | messages/s |
| Vehicles Platooning | 50-6500 | Bytes | 40 | messages/s |
| Advanced Driving | 300-6500 | Bytes | 10 | messages/s |
| Extended Sensors | 1600 | Bytes | 10 | messages/s |

In some application case scenarios (as mentioned in ETSI TR 102 638: Intelligent Transport Systems (ITS); Vehicular Communications; Basic Set of Applications; Definitions) the vehicles can be warned early enough (from 1 to 2 km distance) to control the speed and take necessary precautions. They are not latency constrained as the vehicles are notified of the situation much ahead. The following use case can be V2V, V2I/I2V (broadcast messages):
traffic jam warning: warn vehicles of approaching traffic jam early enough to decrease speed;

The following uses cases can also be included to warn the vehicles early enough:
emergency vehicle warning: an emergency vehicle indicates its approach to vehicles so that they can give way to it;
road obstacle warning: presence of an obstacle is indicated to other vehicles by a vehicle which detects the obstacle;
hazardous location notification: vehicles are notified of any hazardous location on their route;
road work warning: vehicles are notified of any road work on their route;
traffic information and recommended itinerary: warn vehicles of approaching traffic jam early enough and provide an alternate route;
car breakdown warning: warn vehicles of a car breakdown.

As the current traditional algorithms are quantum vulnerable, NIST is in the process of standardizing the key encapsulation algorithms and digital signature algorithms since 2016. The Table 2 shows a comparison of a public key size and a digital signature size of the traditional ECDSA algorithm and NIST finalist digital signature algorithms.

TABLE 2
Digital signature algorithms

| | Public Key | Signature |
|---|---|---|
| Algorithm Name | Size (bytes) | Size (bytes) |
| ECDSA(secp256k1) | 33 | 64 |
| Dilithium2 | 1,312 | 2,420 |
| Dilithium3 | 1,952 | 3,293 |
| Dilithium5 | 2,592 | 4,595 |
| Falcon-512 | 897 | 666 |
| Falcon-1024 | 1,793 | 1,280 |
| SPHINCS + SHA-256 128-bit | 32 | 17,088 |
| SPHINCS + SHA-256 192-bit | 48 | 35,664 |
| SPHINCS + SHA-256 256-bit | 64 | 49,856 |

As seen from the Table 2 the size of the public key and digital signature size of PQC algorithms is much more than the current traditional algorithm. Hence, alternative mechanisms are required to incorporate post-quantum digital signatures in V2V communication.

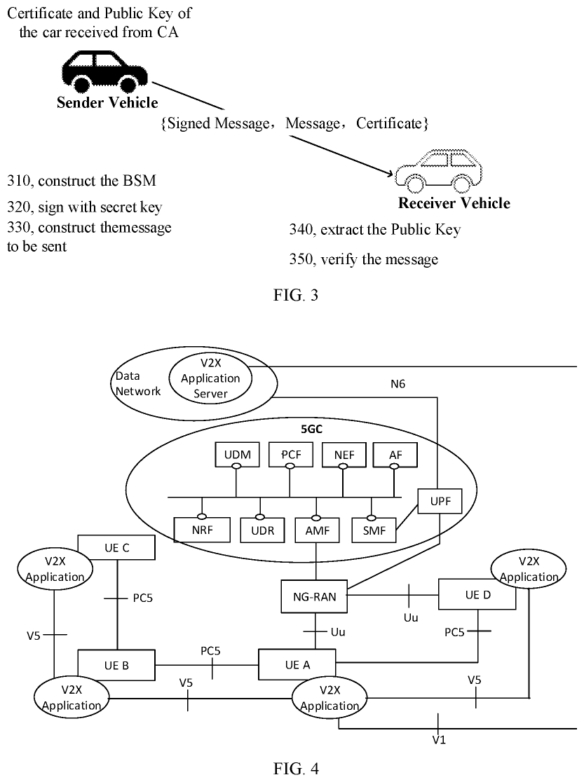

FIG. 3 is a schematic diagram of a V2V communication scenario. In a V2V communication, a vehicle 301, which may alternatively be called user equipment, a sender vehicle, a sender device, a sending device, etc., receives a certificate and a public key from a certificate authority (CA). The CA is a trusted entity that issues digital certificates used to verify identities of individuals, organizations, or electronic devices on a network. A primary function of a CA is to validate the ownership of public keys by associating them with the identity of the owner. This process helps establish trust in electronic transactions and communications.

The sender vehicle constructs a BSM (310), and signs the BSM with its private key (320). Then, the sender vehicle constructs an entire message to be sent (330), i.e., {Signed (BSM), BSM, Certificate}, and broadcasts the entire message.

A vehicle 302, may alternatively be called UE, a receiver vehicle, a receiver device, a receiving device, may obtain the entire message. Then, the receiver vehicle 302 may extract a public key from the certificate (340) and verifies legitimacy of the BSM (350) and notifies a user for further action.

In the above-mentioned process, signing of the message by the sender vehicle is not quantum-safe as it is done with traditional algorithms. As quantum computers develop, these algorithms may become vulnerable to attacks, reducing the security of the signed messages.

The transmitted message has a size limitation, which cannot accommodate the signature and public key of the post-quantum algorithms, since sizes of signatures and public keys of post-quantum algorithms are larger.

The verification process by the receiver vehicle is also not quantum-safe as traditional algorithms are employed to sign by the sender vehicle. This may leave the system susceptible to potential attacks from quantum computers.

In view of the above, embodiments of the present disclosure provide a communication solution which aims to incorporate post-quantum cryptography in V2V communication. Post quantum cryptography typically has very large key sizes and digital signatures, for example, Dilithium5 has a public key size of 2592 bytes and a signature size of 4595 bytes, so it is a challenging task to incorporate the post quantum cryptography in V2V communication compared to a current algorithm (or traditional algorithm), such as, ECDSA that has a public key of 33 bytes and a signature of 64 bytes. Solutions according to embodiments of the present disclosure can achieve the employment of post-quantum cryptography algorithms in V2V communication, and is generalized and satisfies in general for PQC algorithms that may be lattice-based or hash-based signatures. In addition, solutions according to some embodiments of the present disclosure may employ hybrid algorithms in V2V communication, which can make the solutions backwards compatible so that devices that do not support PQC or which follow traditional cryptography may also adapt to the solutions.

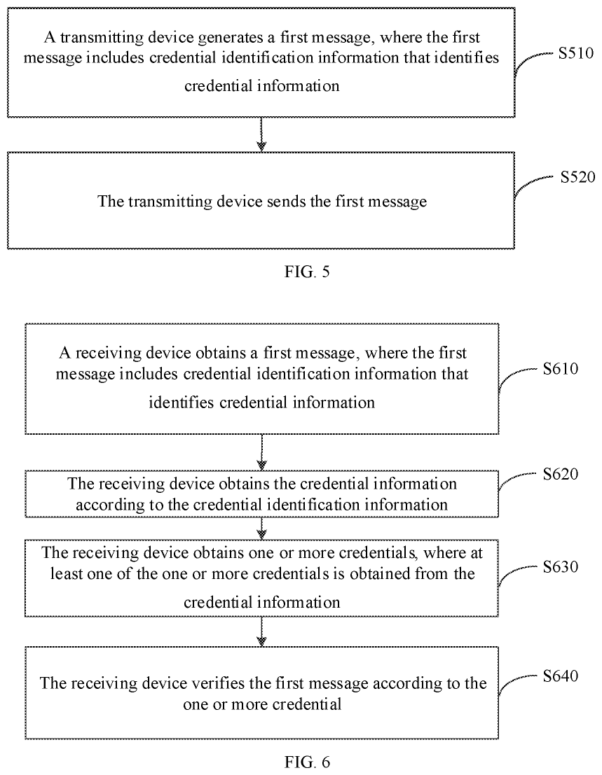

First, an example scenario of the present disclosure will be described before elaborating the solutions of the present disclosure. It should be noted that FIG. 5 shows an example scenario to which solutions proposed by the present disclosure could be applied, and should not be construed as a limitation.

FIG. 4 is a schematic diagram of a V2X communication system in the 5G architecture according to one or more example embodiments of the present disclosure. FIG. 4 shows architecture of non-roaming 5G system for V2X Communication as specified in the 3GPP TS 23.287, to which solutions according to the embodiments of the present disclosure could be applied. In the architecture, each UE (including UE A, UE B, UE C, UE D shown in FIG. 5) communicates by a PC5 interface. The UE has a V2X application which communicates with a V2X application server included in a data network by a V1 interface.

As shown in FIG. 4, a 5G Core Network (5GC) architecture includes several key network functions, including: an access and mobility management function (AMF), a session management function (SMF), a user plane function (UPF), a unified data management (UDM), a policy control function (PCF), a network exposure function (NEF), an application function (AF), a network repository function (NRF), a unified data repository (UDR) etc. These network functions work together to enable the 5G system's advanced capabilities, such as network slicing, low-latency communication, and massive device connectivity. A data network (DN) can communicate with the UPF through a N6 interface.

In the architecture, a next generation radio access network (NG-RAN) is responsible for radio access and communication between the UE and the core network. The UE is connected to the NG-RAN through a Uu interface. The Uu interface is a radio interface between the UE and the NG-RAN, which is responsible for providing wireless connectivity and communication between the UE and the radio access network. Each V2X application communicates with each other by a V5 interface.

Embodiments of the present disclosure can be employed in V2V communication, unmanned aerial vehicle (UAV) communication, a radio-constrained network, IoT devices, any device of any form factor requiring cryptography that are using digital signatures, specially requiring to migrate to post-quantum cryptography that are using post-quantum digital signatures. Solutions disclosed in the present disclosure can also employed in any device or protocol that has constraints on message size and may not be able to fit in the post-quantum signature and public key.

FIG. 5 shows a schematic flowchart of a communication method according to one or more example embodiments of the present disclosure. The method can be implemented by a transmitting device. For ease of description, a V2V communication system is taken as an example in the embodiment, but the principle and the operations performed by also apply for other wireless systems. As shown in FIG. 5, the method can include the following steps.

S510, a transmitting device generates a first message, where the first message includes credential identification information that identifies credential information.

In the embodiment, the transmitting device generates the first message. The first message includes credential identification information that identifies credential information. The credential identification information can also refer to a credential identifier, and may be used to identify credential information, that is used to authenticate an entity or verify the integrity of a message.

The credential identification information allows the receiving device to ascertain an identity of a sending device by referring to the credential information identified by the credential identification information. The inclusion of the credential identification information also helps the receiving device identifying the credential information to verify that the message has not been altered in transit.

The credential identification information may be integrity protected. This means that it would be sent in such a way that any unauthorized alteration of this identifier can be detected by the receiver. This is crucial for maintaining security and trust in the communication system, especially in an environment where messages are critical for safety and coordination among vehicles.

In an implementation, the credential information may include at least one credential. The credential information includes one or more credentials that may be used to authenticate a UE or a message, or used to verify integrity of the message content (or part of). Therefore, one or more credentials may be obtained through the credential identification information and then used for verification of the message, which increases the flexibility of verification.

In an example implementation, the credential information may include multiple different credentials, and the different credentials might be used for different levels. Multiple credentials can provide backup options in case one is compromised or becomes obsolete. Optionally, the multiple credentials may include traditional and post post-quantum credentials.

When the credential information includes at least one credential, a flexible and robust approach to authentication and message integrity verification can be achieved in a V2V communication system. It allows for the use of multiple credentials to address various security concerns and ensure compatibility across different technological standards.

In an implementation, each of the at least one credential includes a certificate where the certificate includes a public key. The certificate is an electronic document issued by a trusted authority (certificate authority or CA) that binds an entity's identity information to its public key. The certificate includes a public key. The public key is part of asymmetric cryptography, where different keys are used for encryption and decryption. In the asymmetric cryptography, each entity has a public-private key pair. The private key is kept secret and only known to the entity itself, while the public key can be shared with others. The public key can be used to verify digital signatures created by the corresponding private key.

The certificate may further include identity information, issuer information or a digital signature. The digital signature is used to ensure the certificate's authenticity, and the digital signature is digitally signed by the CA using its private key.

Since each credential may include a certificate, the certificate could be verified to authenticate the sender of the first message. The public key may be extracted from the certificate, and then be used for verification of the message.

In an implementation, the credential identification information includes a pointer or a uniform resource index (URI)/uniform resource locator (URL) to the credential information. The credential identification information can include a pointer or a URI/URL that serves as a reference to the credential information. The pointer or URI/URL acts as an identifier or address to access the credential information stored separately. It may point to a specific location in, for example, a database, file system, or web server, where the credential details are stored. When the system needs to access the credential information, it follows the pointer or URL to retrieve the associated credential data from the specified location. This retrieval process may involve accessing the resource directly or making a request over a network, depending on the implementation.

In this way, the first message may carry a pointer or a URI/URL to the credential information, through which the credential information can be obtained, and the first message may not need to include the credential information, or at least, may not need to include all the credential information, and thus the message transfer of credential information could be decreased.

S520, the transmitting device sends the first message.

In an example implementation, the first message includes a signed message and a second message, and the signed message includes one or more signatures on the second message, where the second message includes the credential identification information. The first message sent by the transmitting device may include a signed message. The second message includes credential identification information that serves as an identifier or reference to the credential information. The use of a signed message provides several security benefits, such as ensuring the authenticity, integrity, and non-repudiation of the message. By signing the message using a private key, the transmitting device can guarantee that the message has not been tampered with and that it originated from a trusted source. The inclusion of credential identification information in the second message allows the receiving device to locate and retrieve the corresponding credential information according to the credential identification information in the second message.

Since the credential identification information is included in the second message, and the first message includes a signed message and the second message, and the signed message includes one or more signatures on the second message, the content of the second message, which includes the credential identification information, could be integrity protected, thereby ensuring the security of communication.

In an example implementation, the second message further includes a basic safety message (BSM). In the embodiment, the second message sent by the transmitting device can include a BSM in addition to the credential identification information.

The BSM typically includes essential safety-related information that is exchanged between vehicles to enhance overall safety and situational awareness. The safety-related information may include vehicle speed, position, heading, acceleration, vehicle size, and other relevant data. The inclusion of the BSM allows the receiving device to understand and respond to critical safety information from the transmitting device.

Through the credential identification information and signatures, the first message can serve the purpose of ensuring the authenticity and integrity of the transmitted safety-related information. This approach supports secure and authenticated communication between vehicles, which is crucial for maintaining safety and trust in V2V communication systems.

Since the second message may include a BSM along with the credential identification information, the sender of the message may be authenticated through verifying the credential information which may be obtained through the credential identification information included in the second message, and since the first message includes the signed message together with the second message, and the signed message includes the signature(s) on the second message, the content of the BSM and the credential identification information could be integrity protected. Thus, the authenticity of the BSM and trustworthiness of the message sender could be ensured, and meanwhile the message transfer of credential information could be decreased.

In an example implementation, the one or more signatures on the second message are obtained by using one or more signature algorithms with one or more private keys. The signature algorithm is a cryptographic algorithm that takes a message and a private key as input and generates a digital signature, which is a unique representation of the message that is mathematically linked to the private key. The signature algorithm ensures the integrity and authenticity of the message.

In order to obtain the signature(s) on the second message, the transmitting device would typically use its own private key(s) in conjunction with the signature algorithm(s). The private key(s) may be securely stored and known only to the transmitting device to maintain the confidentiality and integrity of the signatures.

When the receiving device receives the message, it can then use the corresponding public key(s), which can be extracted from the certificate(s), along with the same signature algorithm(s) to verify the authenticity and integrity of the message. By comparing the calculated signature(s) with the received signature(s), the receiving device can determine whether the message has been tampered with or whether it originated from the sender.

In an example implementation, generation of the first message may be implemented by generating the second message including the credential identification information; and signing the second message with the one or more private keys by using the one or more signature algorithms. In order to generate the first message, the transmitting device may first generate the second message, where the second message may, for example, include a BSM and the credential identification information that need to be transmitted to the receiving device. Once the second message has been generated, the transmitting device can then sign it with one or more private keys using one or more signature algorithms. When a signature algorithm is used to sign the second message, a corresponding credential may be used on the receiver side for the verification of the message, which provides more choices for the verification.

One or more signature algorithms may be used for obtaining the signature(s). In addition, the second message may be signed with one or more private keys by using one or more signature algorithms. The signature process with one or more private keys and signature algorithms could ensure the integrity and authenticity of the message, and allow for greater flexibility and customization, as different signature algorithms may be utilized based on their specific requirements and security considerations. The signature algorithm(s) may be selected according to actual demands. For example, the selection of the signature algorithm(s) and private key(s) may depend on specific security requirements and standards of the communication system being used, as well as other factors such as computing resources, performance, and scalability. By using one or more signature algorithms, the flexibility of the solution can be increased, allowing for the use of different algorithms depending on the actual demands of the system.

In an example implementation, the one or more signature algorithms respectively correspond to one or more credentials. That is to say, each credential may be associated with a specific signature algorithm. For instance, different signature algorithms may have distinct security levels, cryptographic properties, or compatibility with particular algorithms. As a result, the appropriate signature algorithm(s) may be selected considering the overall security, compatibility, efficiency, etc. of the communication system. When a signature algorithm is used by the transmitting device to sign the message, a corresponding credential may be used by the receiving device to verify the message.

In an example implementation, the one or more signature algorithms include at least one of: at least one first signature algorithm, or at least one second signature algorithm. In an example implementation, the one or more signatures include at least one of: at least one first signature obtained by using at least one first signature algorithm, or at least one second signature obtained by using at least one second signature algorithm.

The system may support multiple signature algorithms, including at least one first signature algorithm and/or at least one second signature algorithm. The choice of which algorithm to use may be based on the specific requirements or preferences of the user or application. The one or more signatures generated during the signing process may include at least one first signature obtained using at least one first signature algorithm, or at least one second signature obtained using at least one second signature algorithm, or both of the first and second signatures. This means that the system may accommodate different numbers and/or different types of signatures depending on the selected signature algorithm(s).

At least one first signature algorithm, or at least one second signature algorithm, or both of them may be used by the transmitting device, and correspondingly the first message may include at least one first signature obtained by using at least one first signature algorithm, or at least one second signature obtained by using at least one second signature algorithm, or both of the first and second signatures. In this way, different numbers or different kinds of signature algorithms may be used according to actual demands, which could increase the flexibility of the solution.

In an example implementation, the first signature algorithm may be a non-post-quantum cryptography (non-PQC) algorithm. The non-PQC algorithm refers to traditional cryptographic algorithms that are not specifically designed to resist attacks from quantum computers. For example, the non-PQC algorithm may include: an elliptic curve cryptography (ECC) algorithm, a rivest-shamir-adleman (RSA) algorithm, an advanced encryption standard (AES), a triple data encryption standard (3DES), a secure hash algorithm 2 (SHA-2) or other traditional cryptographic algorithms. The ECC algorithm may include: an elliptic curve digital signature algorithm (ECDSA), an elliptic curve menezes-qu-vanstone (ECMQV), an elliptic curve integrated encryption scheme (ECIES), an elliptic curve diffie-hellman (ECDH), an elliptic curve direct anonymous attestation (ECDAA).

When a non-PQC algorithm is used, the solution could be backwards compatible so that the devices that follow traditional cryptography may also adapt to the solution. The non-PQC algorithm may require smaller key sizes and less computational resources, and thus, may be more efficient for resource-constrained environments or devices with limited processing power.

In an example implementation, the second signature algorithm may be a post-quantum cryptography (PQC) algorithm. The PQC algorithm is a cryptographic algorithm specifically designed to resist attacks from quantum computers. The PQC algorithm aims to provide security even in the presence of powerful quantum computers. The PQC algorithm may include: Dilithium, Falcon, SPHINCS+, Kyber, or other future PQC algorithms. The Dilithium may include Dilithium2, Dilithium3, or Dilithium5, etc. The Falcon may includes Falcon512, Falcon 1024, etc. The SPHINCS+ may include SPHINCS+SHA-256 128-bit, SPHINCS+SHA-256 192-bit, SPHINCS+SHA-256 256 bit, etc. The Kyber may include Kyber512, Kyber768, Kyber1024, etc.

When a PQC algorithm is used, security of communication could be greatly enhanced, since PQC algorithms are considered quantum-safe. Further, since the credential information may be obtained through the credential identification information, the credential for the PQC algorithm, which is usually large in size, needs not to be included in the message, the message transfer of the credential for the PQC algorithm could be greatly decreased, and the over the air spectrum efficiency could be significantly improved.

In an example implementation, the one or more signatures include a first signature and a second signature, and the at least one credential includes a first credential corresponding to a first signature algorithm used to obtain the first signature and a second credential corresponding to a second signature algorithm used to obtain the second signature. Inclusion of both the first signature and the second signature indicates the use of different signature algorithms. Each signature is created using a respective algorithm. For each signature algorithm used, there is a corresponding credential. The first credential corresponds to the first signature algorithm, while the second credential corresponds to the second signature algorithm. When verifying the signatures at the receiving device, an appropriate credential corresponding to the signature algorithm can be used. This allows for the validation of each signature based on its specific algorithm and associated credential.

Since the first message includes both the first and second signatures obtained by using two signature algorithms, the verification may still be conducted even if the receiver supports only one of the signature algorithms, which could increase the compatibility of the solution. In addition, since the credentials corresponding to the first and second signatures algorithms are both included in the credential information, the credentials for the first and second signatures may be obtained through the credential identification information, and the first message needs not to carry the first and second credentials, and thus the message transfer of the first and second credentials could be decreased.

In an example implementation, the one or more signatures include a first signature and a second signature, the first message further includes a first credential corresponding to a first signature algorithm used to obtain the first signature, and the at least one credential includes a second credential corresponding to a second signature algorithm used to obtain the second signature.

Since the first message includes both the first signature and the second signature, the compatibility of the solution could be improved. In addition, since the first message includes the first credential for the first signature algorithm, verification may be conducted based on the first credential and the first signature in a traditional way, which could make the solution backwards compatible. Moreover, since the second credential is not included in the first message but can be obtained through the credential identification information, the message transfer of the second credential could be decreased.

In an example implementation, the one or more signatures include a first signature, and the at least one credential includes a first credential corresponding to a first signature algorithm used to obtain the first signature; or the one or more signatures include one or more second signatures, and the at least one credential includes at least one second credentials corresponding to one or more second signature algorithms used to obtain the one or more second signatures.

The first message may include either the first signature or the second signature, and the signature algorithm used may be selected according to actual demands. The credential may be obtained through the credential identification information, thereby decreasing the message transfer of the credential information.

In an example implementation, the transmitting device may obtain the at least one credential. The at least one credential may be obtained in advance, for example, from a certificate authority.

In an example implementation, the transmitting device may further perform registration to obtain the credential identification information. The credential information may be registered to a server in advance to obtain the credential identification information that identifies credential information.

The registration process may involve providing the necessary information to the server or other trusted entity that can manage the credential information. When the registration process is complete, the transmitting device can obtain the credential identification information that identifies the credential information for verifying the message. This credential identification information can be used to retrieve the required credential from the server or other trusted entity.

By registering in advance to obtain the credential identification information, the transmitting device can carry the credential identification information in the message, thereby reducing the communication overhead required during the message transmission. This approach also ensures that the necessary credential is readily available when needed.

In an example implementation, performing registration to obtain the credential identification information may include: sending the credential information; and obtaining the credential identification information. The credential information may be sent to the server so that the server can store the credential information and generate the credential identification information. Then, the credential identification information can be obtained from the server, and be included in the first message so that the receiving device can obtain the credential information through the credential identification information.

The transmitting device sends the credential information to the server, which can store and manage the credential information. The server then generates a unique credential identifier, that is, the credential identification information, that corresponds to the stored credential information. This credential identifier can be used by the receiving device to retrieve the credential information when needed.

After obtaining the credential identification information from the server, the transmitting device includes it in the first message sent to the receiving device. When the receiving device receives the message, it can use the credential identification information to retrieve the credential information from the server. This approach eliminates the need for the transmitting device to send the credential information during the transmission of the first message, reducing the communication overhead required for the message exchange.

In an example implementation, the first message may be sent in a broadcast mode. The first message may be a message broadcast by the transmitting device to other devices, and then the other devices receiving the message can obtain the credential information of the transmitting device through the credential identification information included in the first message.

By broadcasting the first message that includes the credential identification information, the transmitting device can share its credential information with multiple receiving devices simultaneously, reducing the message transfer of the credential information during broadcast. The receiving devices can then use the received credential identification information to retrieve the credential information from the server or trusted entity, or from storage if already obtained. This approach can also reduce the risk of security breaches or data leaks during the communication process, as the credential information is not exposed in clear text during the message exchange.

According to one or more embodiments of the present disclosure, the transmitting device generates a first message, where the first message includes credential identification information that identifies credential information; and sends the first message. The credential identification, or called a credential identifier, can reveal public information (that is the credential information) of the sender UE (that is the transmitting device) in a single URL, which the receiver UE (or the receiving device) might require for current and/or future communication. Since the first message includes the credential identification information that identifies credential information, the credential information can be obtained through the credential identification information when needed for verification of the first message, and the first message may not need to include the credential information, thereby decreasing the message transfer of credential information while ensuring the security of communication.

Taking Dilithium5 as an example, if an existing procedure to transmit the message is used (that is transmitting a signed message, an original message, a certificate at the same time), the total number of bytes to be transferred for Dilithium5 is 12,100 bytes. For the present disclosure, only the signed message and the message is transmitted, where the public key and certificates are obtained from the server or from storage if already obtained. Here the total number of bytes to be transmitted for Dilithium5 is 4900 bytes. Hence a total of 59.5% over the air spectrum efficiency could be achieved for 1 message. For 10 BSM/sec the efficiency gained could be 590.5%/sec.

FIG. 6 shows a schematic flowchart of a communication method according to one or more example embodiments of the present disclosure. The method can be implemented by a receiving device. For ease of description, a V2V communication system is taken as an example in the embodiment, but the principle and the operations may also apply for other wireless systems. As shown in FIG. 6, the method can include the following steps.

S610, a receiving device obtains a first message, where the first message includes credential identification information that identifies credential information.

In an example implementation, the credential identification information includes a pointer or a uniform resource index (URI)/uniform resource locator (URL) to the credential information.

The credential identification information can include a pointer or a URI/URL that serves as a reference to the credential information. The pointer or URI/URL acts as an identifier or address to access the credential information stored separately. It may point to a specific location in, for example, a database, file system, or web server, where the credential details are stored. When the system needs to access the credential information, it follows the pointer or URL to retrieve the associated credential data from the specified location. This retrieval process may involve accessing the resource directly or making a request over a network, depending on the implementation.

In this way, the first message may carry a pointer or a URI/URL to the credential information, through which the credential information can be obtained, and the first message may not need to include the credential information, and thus the message transfer of credential information could be decreased.

S620, the receiving device obtains the credential information according to the credential identification information.

In the embodiment, the receiving device obtains the credential information according to the credential identification. Specifically, the receiving device may obtain the credential identification information according to the credential identification from a server. The credential information may be stored in a server, and after the credential identification information is obtained, the credential information may be obtained through the credential identification information from the server. Storing the credential information in a server allows for centralized management and storage.

In an example implementation, the receiving device may send the credential identification information to the server; and receive the credential information identified by the credential identification information from the server. When obtaining the credential identification information from a server, the credential identification information may be sent to the server so that the server can identify the credential information according to the credential identification information and send back the credential information. Then the receiving device can receives the credential information identified by the credential identification information from the server.

By way of example rather than limitation, the receiving device may send a request to the server, indicating the credential identification for which it needs the corresponding credential information. The request may include necessary parameters for the server to identify and locate the specific credential information. Upon receiving the request, the server processes it to identify the requested credential identification. This may involve querying a database, searching through a file system, or accessing other storage mechanisms where the credential information is stored. When the server has obtained the requested credential identification, the server may generate a response to the receiving device. The response may include the credential information. The receiving device receives the response from the server, which includes the credential information, and can then retrieve the credential information. In this way, the receiving device can obtain the credential information according to the credential identification information from the server.

In an example implementation, the receiving device may store the credential information identified by the credential identification information locally. After obtaining the credential information, it can be stored locally for future use, thereby reducing transmission of the credential information.

Storing the credential information locally minimizes the need to retrieve it from a server repeatedly. The receiving device may obtain the credential information locally, instead of obtaining the credential information from the server every time. By avoiding frequent transmissions, it reduces network traffic and conserves bandwidth. Since the credential information is stored locally, the receiving device can access it quickly without being affected by network latency or availability.

In an example implementation, the credential identification information can be obtained according to the credential identification from a server in a case that the credential identification information is not stored locally in the receiving device. When the credential information has been stored, it can be obtained based on the credential identification information from storage, and the credential identification information needs not to be sent to the server for obtaining the credential information. When the credential information is not stored, the credential identification information can be sent to the server to obtain the credential information. In this way, transmission between the message receiver and the server for obtaining the credential information could be reduced and transmission resources could be saved. The credential information may be valid in a period of time. In such a case, if the valid period of time for a piece of stored credential information expires, the credential information may still needs to be obtained from the server.

In an example implementation, the receiving device may stores a limited number of frequently used credentials locally. If a credential that's not stored locally is needed, the receiving device can retrieve it from the server. The device may keep track of usage statistics for each credential. The usage statistics could include the number of times a particular credential has been used or accessed within a certain time frame, or the length of time since a particular credential was last used or accessed. Based on predefined criteria (such as, a threshold), the device can determine whether a credential is frequently used. Optionally, the frequently used credential may be pre-configured. By storing only the frequently used credentials, the storage requirements on the receiver device can be significantly reduced. This can be advantageous when the device has limited storage capacity.

S630, the receiving device obtains one or more credentials, where at least one of the one or more credentials is obtained from the credential information.

In an example implementation, the receiving device may obtain the one or more credentials from the credential information. In other words, all the credentials required for verification are obtained from the credentials identified by the credential identifier.

In an example implementation, the receiving device may obtain part of the one or more credentials from the credential information. Some of the credentials needed for verification are obtained from the credentials identified by the credential identifier. While some credentials can be retrieved from the specified sources, there may be other credentials required for verification that are obtained from different sources or methods.

In an example implementation, the first message includes a signed message and a second message, and the signed message includes one or more signatures on the second message, where the second message includes the credential identification information. Specifically, the second message includes credential identification information that serves as an identifier or reference to the credential information, and the first message sent by the transmitting device can be a signed message, which includes the second message and at least one signature on the second message. The use of a signed message can provide several security benefits, such as ensuring the authenticity, integrity, and non-repudiation of the message.

Since the credential identification information is included in the second message, and the first message includes a signed message and the second message, and the signed message includes one or more signatures on the second message, the content of the second message, which includes the credential identification information, could be integrity protected, thereby ensuring the security of communication.

In an example implementation, the second message further includes a BSM. Since the second message may include a BSM along with the credential identification information, the sender of the message can be authenticated through verifying the credential information, which can be obtained through the credential identification information included in the second message, and since the first message includes the signed message and the second message, and the signed message includes the signature(s) on the second message, the content of the BSM and the credential information can be integrity protected. Thus, the authenticity of the BSM and trustworthiness of the message sender can be ensured, and meanwhile the message transfer of credential information can be decreased.

In an example implementation, the one or more signatures are obtained by using one or more signature algorithms, and each of the one or more signatures is obtained by using one of one or more signature algorithms. One or more signature algorithms may be used for obtaining the signature(s). The signature algorithm(s) may be selected according to actual demands, which could increase the flexibility of the solution.

In an example implementation, the first message may include a signature on the second message, and the signature is obtained by using one of one or more signature algorithms. In another possible implementation, the first message includes two or more signatures obtained by using different algorithms.

In an example implementation, the one or more credentials respectively correspond to the one or more signature algorithms. When a signature algorithm is used, a corresponding credential may be used for the verification of the message, which provides more choices for the verification.

In an example implementation, the one or more signatures include at least one of: at least one first signature obtained by using at least one first signature algorithm, or at least one second signature obtained by using at least one second signature algorithm. The first message may include:

at least one first signature obtained by using at least one first signature algorithm, or at least one second signature obtained by using at least one second signature algorithm, or both of the first and second signatures. In this way, different numbers or different kinds of signature algorithms may be used according to actual demands, which could increase the flexibility of solution.

The system may support multiple signature algorithms, including at least one of a first signature algorithm or a second signature algorithm. The choice of which algorithm to use may be based on the specific requirements or preferences of the user or application. The one or more signatures generated during the signing process may include: a first signature obtained using the first signature algorithm, a second signature obtained using the second signature algorithm, or both of the first and second signatures. This means that the system may accommodate different numbers and/or different types of signatures depending on the selected signature algorithm(s).

In an example implementation, the first signature algorithm is a non-PQC algorithm. When a non-PQC algorithm is used, the solution could be backwards compatible so that the devices that follow traditional cryptography may also adapt to the solution. The non-PQC algorithm refer to traditional cryptographic algorithms that are not specifically designed to resist attacks from quantum computers Specifically, the non-PQC algorithm in the embodiment may be any of the above-mentioned non-PQC algorithms, which will not be repeated here.

When a non-PQC algorithm is used, the solution could be backwards compatible so that the devices that follow traditional cryptography may also adapt to the solution. The non-PQC algorithm may require smaller key sizes and less computational resources, and thus may be more efficient for resource-constrained environments or devices with limited processing power.

In an example implementation, the second signature algorithm is a PQC algorithm. The PQC algorithm is a cryptographic algorithm specifically designed to resist attacks from quantum computers. The PQC algorithm aims to provide security even in the presence of powerful quantum computers. Specifically, the PQC algorithm in the embodiment may be any of the above-mentioned PQC algorithms, or other future PQC algorithms, which will not be repeated here.

When a PQC algorithm is used, security of communication could be greatly enhanced, since PQC algorithms are quantum-safe. Further, since the credential information may be obtained through the credential identification information, the credential for the PQC algorithm, which is usually large in size, needs not to be included in the message, and thus, the message transfer of the credential for the PQC algorithm could be greatly decreased, and the over the air spectrum efficiency could be significantly improved.

In an example implementation, the receiving device may obtain the one or more credentials from the credential information. The one or more credentials may all be obtained from the credential information, and the first message needs not to carry the one or more credentials, thereby decreasing the message transfer of the credential(s).

In an example implementation, the one or more signatures include a first signature and a second signature, and the first message further includes a first credential corresponding to a first signature algorithm used to obtain the first signature, and the receiving device may obtain the first credential from the first message; and obtain a second credential corresponding to a second signature algorithm used to obtain the second signature from the credential information. Since both the first signature and the second signature are included in the first message, security of communication may be enhanced. Meanwhile, since the first message includes two signatures obtained by using two signature algorithms, the verification may still be conducted even if the receiver supports only one of the signature algorithms, thereby increasing the compatibility of the solution. In addition, since the first message includes the first credential for the first signature algorithm, verification may be conducted based on the first credential and the first signature in a traditional way, which makes the solution backwards compatible. Moreover, since the second credential is not included in the first message but can be obtained through the credential identification information, the message transfer of the credential information could be decreased.

S640, the receiving device verifies the first message according to the one or more credential.

In an example implementation, the receiving device may verify legitimacy of the second message by using the one or more signature algorithms according to the one or more credentials. The legitimacy of the second message may be verified using one or more signature algorithms based on one or more corresponding credentials, which may enhance security of communication and improve flexibility of the solution. By using the one or more signature algorithms based on the corresponding credentials, the receiving device can ensure that the second message has not been tampered with or modified during transmission.

In an example implementation, the one or more credentials include one or more public keys respectively corresponding to the one or more signature algorithms, and the receiving device may verify the one or more signatures by using the one or more signature algorithm with the one or more public keys. Each signature may be verified by using a corresponding signature algorithm with a public key obtained from a corresponding credential, thereby verifying the legitimacy of the second message. Each of the one or more public keys corresponds to a signature algorithm respectively. That is to say, for each signature algorithm used in the first message, there is a corresponding public key included in the credentials. When verifying the signatures in the second message, the receiving device can use the appropriate signature algorithm and the corresponding public key obtained from the credentials to authenticate each signature, which ensures that each signature is verified using the correct algorithm and public key, and adds an extra layer of security to the communication process.

In an example implementation, the one or more credential includes one or more certificates respectively corresponding to the one or more signature algorithms, and the receiving device may verify the one or more certificates. Based on the certificate(s), the receiver can verify that the message comes from a legitimate sender and that the signature is authentic. The certificate(s) included in the credential(s) may be verified to authenticate the sender of the message, thereby ensuring the security of the communication.

In an example implementation, the first message is a broadcast message. The first message may be a message broadcast by a transmitting device to other devices, and then the other devices receiving the message can obtain the credential information of the transmitting device through the credential identification information included in the first message, thereby decreasing the message transfer of the credential information during broadcast.

In the embodiment of the present disclosure, the receiving device obtains a first message, where the first message includes credential identification information that identifies credential information; obtains the credential information according to the credential identification information; obtains one or more credentials, where at least one of the one or more credentials is obtained from the credential information; and verifies the first message according to the one or more credential.

Since the first message includes the credential identification information that identifies credential information, the credential information can be obtained through the credential identification information. In addition, since at least one credential to be used for verification can be obtained from the credential information, the first message needs not carry all the credential(s) needed for verification, thereby decreasing the message transfer of credential information while ensuring the security of communication.

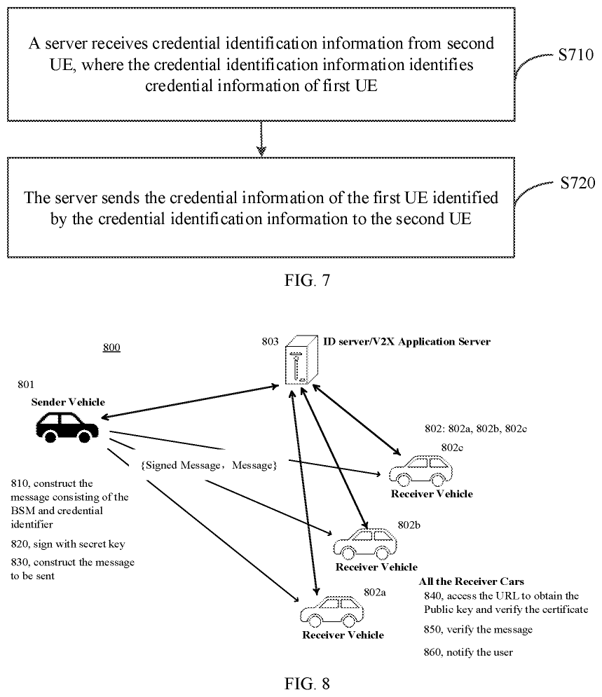

FIG. 7 shows a schematic flowchart of a communication method according to one or more example embodiments of the present disclosure. The method can be implemented by a server. For ease of description, a V2V communication system is taken as an example in the embodiment, but the principle and the operations also apply for other wireless systems. As shown in FIG. 7, the method can include the following steps.

S710, a server receives credential identification information from second UE, where the credential identification information identifies credential information of first UE.

In the embodiment, the server receives credential identification information from second UE, and the second UE may be a receiving device as mentioned above. The received credential identification information is used to identify credential information of the first UE, and the first UE may be a transmitting device as mentioned above.

In an example implementation, the credential information of the first UE includes at least one credential of the first UE. Therefore, one or more credentials may be obtained through the credential identification information, which increases the flexibility of the solution.

In an example implementation, each of the at least one credential includes a certificate, where the certificate includes a public key. Since each credential may include a certificate, the certificate may be verified to authenticate the first UE. The public key may be extracted from the certificate, and then be used for verification of the messages sent from the first UE.

In an example implementation, the server may further perform registration for the first UE. The credential information of the first UE may be registered to the server in advance so that the first UE can get the credential identification information that identifies credential information.

The credential identification information may serve as a reference to identify and retrieve the registered credential information when needed.

In an example implementation, the server may receive the credential information of the first UE, and store the credential information of the first UE. The server then may generate the credential identification information that identifies the credential information of the first UE, and send the credential identification information. The credential information of the first UE may be received and stored by the server, and the credential identification information that identifies the credential information may be generated and sent back. In this way, the credential information of the first UE can be registered, and the first UE can get the credential identification information and include the same in messages sent to other UE so that other UE can obtain the credential information through the credential identification information.

In an example implementation, the at least one credential corresponds to at least one signature algorithm respectively. One or more credentials may be registered, where each credential corresponds to a signature algorithm and can be used for the verification of messages signed using that signature algorithm, which could increase the flexibility of the solution.

S720, the server sends the credential information of the first UE identified by the credential identification information to the second UE.

In an example implementation, the credential information includes at least one of: at least one first credential corresponding to at least one first signature algorithm, or at least one second credential corresponding to at least one second signature algorithm. The credential information may include different numbers of credentials for different signature algorithms, which could increase the flexibility of the solution

In an example implementation, the first signature algorithm is a non-PQC algorithm. The non-PQC algorithm may refer to traditional cryptographic algorithms that are not specifically designed to resist attacks from quantum computers. Specifically, the non-PQC algorithm in the embodiment may be any of the above-mentioned non-PQC algorithms, which will not be repeated here. When a non-PQC algorithm is used, the solution could be backwards compatible so that the devices that follow traditional cryptography may also adapt to the solution.

In an example implementation, the second signature algorithm is a PQC algorithm. The PQC algorithm is a cryptographic algorithm specifically designed to resist attacks from quantum computers. Specifically, the PQC algorithm in the embodiment may be any of the above-mentioned PQC algorithms, or other future PQC algorithms, which will not be repeated here. When a PQC algorithm is used, communication security between the first UE and the second could be greatly enhanced, since PQC algorithms are quantum-safe. Further, since the credential information may be obtained through the credential identification information, the credential for the PQC algorithm, which is usually large in size, needs not to be included in the messages transmitted between the first UE and the second UE, the message transfer of the credential for the PQC algorithm could be greatly decreased, and the over the air spectrum efficiency could be significantly improved.

According one or more embodiments of the present disclosure, the server receives credential identification information from second UE, where the credential identification information identifies credential information of first UE; and sends the credential information of the first UE identified by the credential identification information to the second UE.

Since the credential identification information of the first UE can be received from the second UE, and the credential information of the first UE, which is identified by the credential identification information of the first UE, can be sent to the second UE, the credential information can be obtained through the credential identification information, and thus, messages sent from the first UE to the second UE may not need to carry the credential information of the first UE, which could decrease the message transfer of credential information while ensuring the security of communication.

In the one or more embodiments of the present disclosure, the communication system may be a post-quantum safe V2V communication system and may be also compatible to a non-PQC V2V communication system. The communication system may be a V2V communication system with Hybrid Signatures. The V2V Communication may be with explicit traditional certificate and non-PQC and PQC hybrid signatures. In the communication system, a transmitting device, e.g., a vehicle or UE may register to a server, e.g., an ID server or a V2X Application server.

The transmitting device transmits a message including a credential identifier, which is used to identify one or more credentials (e.g. certificates and public keys) that are used to authenticate the UE (or message) or verify integrity of the message content (or part of). The identifier is integrity protected. The credentials can be stored in an application server.

In an example implementation, the credential identifier is only used for the credentials that employing a PQC algorithm or non-PQC algorithm.

The receiving device may receive the message including a credential identifier, and identify the credential based on the credential identifier. In an example implantation, in the case that the credential(s) corresponding to the credential identifier has not been stored in the receiving device, the receiving device may access the URL to extract the certificate(s) and public key(s). In another possible implantation, in a case that the credential(s) corresponding to the credential identifier has been stored in the receiving device, the receiving device may identify the credential(s) through a storage at the receiving device.

For different types of receiving devices, for example, devices supporting different signature algorithms, which may include, receiving devices only supporting non-PQC algorithm(s), receiving devices only supporting non-PQC algorithm(s) and receiving devices supporting hybrid cryptography (that is, supporting both PQC algorithm(s) and non-PQC algorithm(s)), specific methods for identifying the credential(s) may be different. The receiving device may identify the credential(s) with respect to algorithm(s) used in the message received and supported by the receiving device.

In an example implementation, the message includes one or more credential identifiers for the PQC algorithm(s) and one or more legacy credential(s) (for non-PQC algorithm(s)).

After identifying the credential(s), the receiving device can verify the message by using the credential(s).

The server, for example the AS may store the credential identifier that identifies the credential(s), specially credential(s) with respect to PQC algorithm. The credential is used to authenticate the transmitting device (or the message). The AS can also identify the credential based on the credential identifier received from the receiving device and responses with the credential.

In the present disclosure, the credential identifier which is used to identify one or more credentials (e.g. certificates or public keys) is transmitted in place of the entire certificate and public key, hence which reduces the size of the message transmitted and also ensures security.

FIG. 8 is a schematic illustration of communication among devices according to one or more example embodiments of the present disclosure. As shown in FIG. 8, a wireless communication system 800 involves multiple devices 801, 802a, 802b, 802c and a server 803. The devices may include a transmitting device 801 sending a message, which may be a sender vehicle, and multiple receiving devices 802a, 802b, 802c receiving the message, which may be receiver vehicles.

The transmitting device 801 and the receiving devices 802 may be any suitable end user device capable of wireless communication. As an example, the wireless communication system 800 is a V2V communication system, and the transmitting device 801 and the receiving devices 802 are vehicles that support the V2V communication.

In FIG. 8, the transmitting device 801 may receive at least one certificate from a CA. The certificate includes a public key. The server 803 may be an ID server or a V2X application server, and stores public information, e.g, Public Key(s), Certificate(s), Source-Layer2 ID(s), about a sender vehicle, for example, the transmitting device 802. The public information includes credential information, which includes public key(s), certificate(s). The source-Layer2 ID refers to an identifier associated with a data link layer (Layer 2) of an OSI model. In the context of V2V communication or V2X communication, the source-Layer2 ID is a unique identifier assigned to a transmitting device's data link layer. The source-Layer2 ID serves as a means to uniquely identify the transmitting device 802 within a communication network at a data link layer.

The transmitting device 801 may obtain a credential identifier from the server 803, which may be an identifier for its public information stored in the server. The credential identifier may be an Indicator/Pointer or URL to the public information about the transmitting device 802 stored in the server 803. The URI/URL is stored by the transmitting device 801 which is shared later with other vehicles during broadcast.

During V2V communication, the transmitting device 801 may construct a message at 810, and the message consists of a basic safety message and the credential identifier for its public information stored in the sever 803. The transmitting device 801 may sign the message with its private key(s) at 820. Then, the transmitting device 801 may construct an entire message to be sent at 830, i.e., {Signed (message), message}, and broadcast the message. The entire message includes the message and one or more signatures on the message.

A receiving device 802 that receives the entire message from the transmitting device 801 may identify the credential(s) (e.g. including certificate(s) and public key(s)) based on the credential identifier, either through the server 803, or through storage at the receiving device 802 (if already stored).

In the case that the credential(s) corresponding to the credential identifier has been stored in the receiving device, the receiving device 802 may identify the credential(s) through a storage at the receiving device 802.

In the case that the credential(s) corresponding to the credential identifier has not been stored in the receiving device, the receiving device may access the URL to extract the certificate(s) and public key(s) at 940. For example, the transmitting device 801 may send the credential identifier to the server 803, the server 803 can identify the credential(s) based on the credential identifier received from the receiving device 802 and responses with the credential(s) and then the receiving device 802 receives the credential(s) from the server 803. After that, the receiving device may store the mapping between the credential identifier and the credential(s) locally for future use.

After identifying the credential(s), the receiving device can verify the message by using the credential(s). The receiving device 802 may verify the certificate(s) at 840. Then, the receiving device 802 may verify legitimacy of the message at 850. If the message is determined legitimate, the receiving device 802 may notify a user for further action at 860, such as taking appropriate measures based on received information.

In an example implementation, the communication system 800 may be a post-quantum safe V2V communication system, and correspondingly, the signature(s) may be PQC signature(s) and the credential identifier may be used for the credential(s) that employing a PQC algorithm.

In an example implementation, the communication system 800 may adopt traditional signature algorithm(s), and the signature(s) may be non-PQC signature(s) and the credential identifier may be used for the credential(s) that employing a non-PQC algorithm.

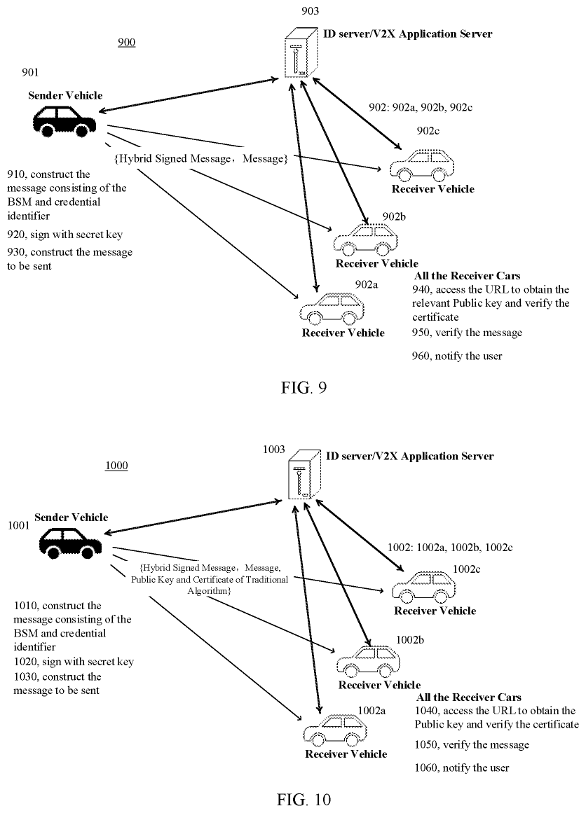

FIG. 9 is a schematic illustration of another communication among devices according to one or more example embodiments of the present disclosure. As shown in FIG. 9, a wireless communication system 900 includes a transmitting device 1001 (e.g. a sender vehicle), multiple receiving devices 902 (e.g., a receiver vehicle 902a, a receiver vehicle 902b and a receiver vehicle 902c) and a server 903.

The transmitting device 901 and the receiving devices 902 may be any suitable end user device capable of wireless communication. As an example, the wireless communication system 900 is a V2V communication system, and the transmitting device 901 and the receiving devices 902 are vehicles that support the V2V communication.

In FIG. 10, the transmitting device 901 receives at least one certificate from a CA. The certificate includes a public key. The server 903 may be an ID server or a V2X application server, and stores public information, e.g. Public Key(s), Certificate(s), Source-Layer2 ID(s), about a sender vehicle, for example, the transmitting device 902. The public information includes credential information, which includes public key(s), certificate(s).

The transmitting device 901 may obtain credential identification information from the server 903, which may be a credential identifier for its public information stored in the server. The credential identifier may be an Indicator/Pointer or URL to the public information about the transmitting device 902 stored in the server 903. The URI/URL is stored by the transmitting device 901 which is shared later with other vehicles during broadcast.

During V2V communication, the transmitting device 901 may construct a message at 910, which includes a basic safety message and the credential identifier for its public information stored in the sever 903. The transmitting device 901 may sign the message with its private keys at 920, and the private keys include a traditional cryptography private key and a PQC signed private key. In other words, the message is signed with the traditional cryptography private key and concatenated with PQC signed private key. At 930, the transmitting device 901 constructs an entire message to be sent, i.e., {Hybrid Signed (message), message}, and broadcasts the message. In the embodiment, the entire message is a hybrid signed message. The multiple signatures on the message may the concatenation of a traditional signature, e.g. ECDSA signature, and a post-quantum signature, e.g. Dilithium5 signature, or all of the multiple signatures may be post-quantum signatures. The traditional signature may be any one of the above-mentioned non-PQC signatures, and the post-quantum signature may be any one of the above-mentioned PQC signatures or other future PQC algorithms.

A receiving device 902 that receives the entire message from the transmitting device 901 may identify the credential(s) (e.g. including certificate(s) and public key(s)) based on the credential identifier, either through the server 903, or through storage at the receiving device 902 (if already stored).

In a case that the credential(s) corresponding to the credential identifier has been stored in the receiving device, the receiving device 902 may identify the credential(s) through a storage at the receiving device 902.

In a case that the credential(s) corresponding to the credential identifier has not been stored in the receiving device, the receiving device may access the URL to extract the certificate(s) and public key(s) at 1040. For example, the receiving device 902 may send the credential identifier to the server 903, the server 903 can identify the credential(s) based on the credential identifier received from the receiving device 902 and responses with the credential(s) and then the receiving device 902 receives the credential(s) from the server 903. After that, the receiving device may store the mapping between the credential identifier and the credential(s) locally for future use.

Considering that, in practical application, some receiving devices may support only PQC, some receiving devices may support only non-PQC and some receiving devices may support hybrid cryptography, i.e. both PQC and non-PQC, for different types of receiving devices, specific methods for identifying the credential(s) may be different. The receiving device may obtain relevant public key(s). For example, if a receiving device is capable to compute only traditional algorithm(s) or only PQC algorithm(s), then the receiving device extracts public key(s) related to traditional algorithm(s) or PQC algorithm(s).

In the case that the receiving vehicle 902 is capable to compute only traditional algorithm(s), for example, only ECDSA compatible, the receiving vehicle 902 may access the URL to extract the certificate(s) and public key(s) with respect to ECDSA from the server, or the receiving vehicle 902 may identify the credential(s) with respect to ECDSA through a storage at the receiving device 902.

In the case that the receiving vehicle 902 is capable to compute only PQC algorithm(s), that is only Post-Quantum compatible, the receiving vehicle 902 may access the URL to extract the certificate(s) and public key(s) with respect to PQC from the server, or the receiving vehicle 902 may identify the credential(s) with respect to ECDSA through a storage at the receiving device 902.

In the case that the receiving vehicle 902 is capable to compute both traditional algorithm(s) and PQC algorithm(s), that is, the receiving vehicle 902 is a hybrid vehicle, the receiving vehicle 902 may access the URL to extract the certificate(s) and public key(s) with respect to both PQC algorithm(s) and traditional algorithm(s) from the server, or the receiving vehicle 902 may identify the credential(s) with respect to both PQC algorithm(s) and traditional algorithm(s) through a storage at the receiving device 902.

After identifying the credential(s), the receiving device can verify the message by using the credential(s). The receiving device 902 may verify the certificate(s) at 940. Then, the receiving device 902 may verify legitimacy of the message at 950. If the message is determined legitimate, the receiving device 902 may notify a user for further action at 960, such as taking appropriate measures based on received information.

The embodiment of the present disclosure allows for secure communication between vehicles using a combination of traditional and post-quantum cryptography, catering to different vehicle capabilities and cryptographic requirements.

FIG. 10 is a schematic illustration of communication among devices according to one or more example embodiments of the present disclosure. As shown in FIG. 10, a wireless communication system 1000 includes a transmitting device 1001 (e.g, sender vehicle), multiple receiving devices 1002 (namely a receiver vehicle 1002a, a receiver vehicle 1002b and a receiver vehicle 1002c) and a server 1003.

The transmitting device 1001 and the receiving devices 1002 may be any suitable end user device capable of wireless communication. As an example, the wireless communication system 1000 is a V2V communication system, and the transmitting device 1001 and the receiving devices are vehicles that support the V2V communication.

In FIG. 10, the transmitting device 1001 receives at least one certificate from a CA. The certificate includes a public key. The server 1003 may be an ID server or a V2X application server, and stores public information, e.g, Public Key(s), Certificate(s), Source-Layer2 ID(s), about a sender vehicle, for example, the transmitting device 1002. The public information includes credential information, which includes public key(s), certificate(s). The source-Layer2 ID refers to an identifier associated with a data link layer (Layer 2) of an OSI model. In the context of V2V communication or V2X communication, the source-Layer2 ID is a unique identifier assigned to a transmitting device's data link layer. The source-Layer2 ID serves as a means to uniquely identify the transmitting device 1002 within a communication network at a data link layer.

The transmitting device 1001 may obtain credential identification information from the server 1003, which may be a credential identifier for its public information stored in the server. The credential identifier may be an Indicator/Pointer or URL to the public information about the transmitting device 1002 stored in the server 1003. The URI/URL is stored by the transmitting device 1001 which is shared later with other vehicles during broadcast.

During V2V communication, the transmitting device 1001 may construct a message at 1010, which includes a basic safety message and the credential identifier for its public information stored in the sever 1003. The transmitting device 1001 may sign the message with its private keys at 1020, and the private keys include a traditional cryptography private key and a PQC signed private key. In other words, the message is signed with the traditional cryptography private key and concatenated with PQC signed private key. At 1030, the transmitting device 1001 may construct an entire message to be sent, i.e., {Hybrid Signed (message), message, public key and certificate of traditional algorithm}, and broadcasts the message. In the embodiment, the entire message is a hybrid signed message. The multiple signatures on the message may the concatenation of a traditional signature e.g. ECDSA signature, and a post-quantum signature e.g. Dilithium2 signature, or all of the multiple signatures may be post-quantum signatures. The traditional signature may be any of the above-mentioned non-PQC signatures, and the post-quantum signatures may be any of the above-mentioned PQC signatures. The public key and the certificate of the traditional algorithm is explicitly included in the message, and the credential identifier is only used for the public key and the certificate of the post-quantum algorithm stored in the server 1003.

A receiving device 1002 that receives the entire message from the transmitting device 1001 may obtain the credential (e.g. including certificate and public key) of the traditional algorithm from the entire message, and may identify the credential(s) (e.g. including certificate(s) and public key(s)) of the PQC algorithm based on the credential identifier through the server 1003, or through storage at the receiving device 1002 (if already stored).

In a case that the credential(s) of the PQC algorithm corresponding to the credential identifier has been stored in the receiving device, the receiving device 1002 may identify the credential(s) of the PQC algorithm through a storage at the receiving device 1002.

In a case that the credential(s) corresponding to the credential identifier has not been stored in the receiving device at 1040, the receiving device 1002 may access the URL to extract the certificate(s) and public key(s) of the PQC algorithm. For example, the receiving device 1002 may send the credential identifier corresponding to the credential(s) of the PQC algorithm to the server 1003, the server 1003 can identify the credential(s) of the PQC algorithm based on the credential identifier received from the receiving device 1002 and responses with the credential(s) and then the receiving device 1002 receives the credential(s) from the server 1003. After that, the receiving device may store the mapping between the credential identifier and the credential(s) locally for future use.

Considering that, in practical application, some receiving devices may support only PQC, some receiving devices may support only non-PQC and some receiving devices may support hybrid cryptography, e.g. both PQC and non-PQC, then for different receiving devices, specific methods for identifying the credential(s) may be different.

In a case that the receiving vehicle 1002 is capable to compute only traditional algorithm(s), for example, only ECDSA compatible, the receiving vehicle 1002 may extract the public key(s) and the certificate(s) with respect to ECDSA from the entire message transmitted by the transmitting device 1001, and would not obtain the public key(s) and the certificate(s) of the post-quantum algorithm from the server.

In a case that the receiving vehicle 1002 is capable to compute only PQC algorithm(s), that is only Post-Quantum compatible, the receiving vehicle 1002 may access the URL to extract the certificate(s) and public key(s) with respect to PQC from the server, or the receiving vehicle 1002 may identify the credential(s) with respect to PQC through a storage at the receiving device 1002. In an example implementation, the receiving vehicle 1002 may not extract the public key(s) and the certificate(s) with respect to traditional algorithm(s) from the entire message transmitted by the transmitting device 1001.

In a case that the receiving vehicle 1002 is capable to compute both traditional algorithm(s) and PQC algorithm(s), that is, the receiving vehicle 1002 is a hybrid vehicle, the receiving vehicle 1002 may extracts the public key(s) and the certificate(s) with respect to traditional algorithm(s) from the entire message transmitted by the transmitting device 1001, and access the URL to extract the certificate(s) and public key(s) with respect to PQC algorithm(s) from the server, or the receiving vehicle 1002 may identify the credential(s) with respect to the PQC algorithm(s) through a storage at the receiving device 1002 if already stored.

After identifying the credential(s), the receiving device can verify the message by using the credential(s). The receiving device 1002 may verify the certificate(s) at 1040. Then, the receiving device 1002 may verify legitimacy of the message at 1050. If the message is determined legitimate, the receiving device 1002 may notify a user for further action at 1060, such as taking appropriate measures based on received information.

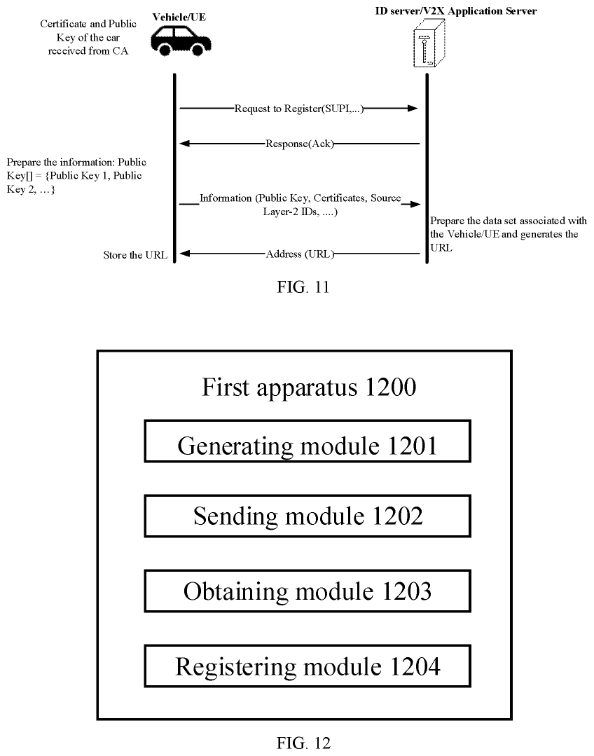

FIG. 11 is a schematic illustration of a registration scenario according to one or more example embodiments of the present disclosure, where registration of a vehicle/UE to an ID server/V2X Application Server is taken as an example. The vehicle/UE may be any transmitting device in above embodiments, and the ID server/V2X Application Server may be any server in above embodiments. The vehicle is a vehicle that supports V2V communication.

In FIG. 11, the vehicle receives at least one certificate of the vehicle from a CA. The certificate includes a public key. The ID server may store public information, e.g, Public Key(s), Certificate(s), Source-Layer2 ID(s), about the vehicle. The public information includes credential information, which includes public key(s), certificate(s).

The vehicle may send a request to register, e.g., Request to Register (SUPI) to the server. The request includes a subscription permanent identifier (SUPI) of the UE. The SUPI uniquely identifies the UE (which is a subscriber) and is used for routing and addressing purposes within a network.

After receiving the request, the server may send a response, e.g., Response (ACK) to the vehicle, then the procedure could proceed.

The vehicle then may prepare information of all publicly available data it possesses i.e., public key(s), certificate(s), e.g. Public Key[ ]={Public Key 1, Public Key 2, . . . }. The Vehicle sends the information including the public key(s), the certificate(s), source-Layer2 ID(s), e.g., Information (Public Key, Certificates, Source-Layer2 IDs) to the server. The public key may be an array of public keys as the vehicle may hold multiple public keys, the certificates issued by the CA and the Source-Layer 2 IDs.

After receiving the information from the vehicle, the server may prepare a data set associated with vehicles and generates a URL/URI or an identifier where public information of the vehicle is stored.

The server may transmit the URL, e.g., Address (URL) to the transmitting device 1201. The vehicle then stores the URL so that it can share with other vehicles during broadcast message.

In the embodiment, the V2X application server is a server providing services of V2X application. The ID server is a server holding the data associated with a UE, e.g. the transmitting device 1201, that is used to identify and authenticate the UE, for e.g., Public key(s), Certificate(s), Source Layer-2 ID(s).

The URL is a resource locator that points to the corresponding UE's data stored in the V2X application server/ID server. The multiple public keys includes a public key related to traditional algorithm (e.g. ECDSA) and a public key related to post quantum algorithm (e.g. Dilithium). For example the server may hold Public Key[ ]={Public Key1, Public Key2, . . . }, where Public Key 1 is a public key related to a traditional algorithm, and Public Key 2 is a public key related to a post quantum algorithm. The vehicle can hold more than one public key.

Next, embodiments of products related to the wireless communication methods will be described.

FIG. 12 shows a schematic structural diagram of a first apparatus according to one or more example embodiments of the present disclosure. The first apparatus may be applied to the transmitting device described above, or installed in or applied to a chip in the transmitting device or any other equipment, module, circuit or unit that can implement the steps of the transmitting device in above method embodiments. As shown in FIG. 12, a first apparatus 1200 may include:
a generating module 1201, configured to generate a first message, where the first message includes credential identification information that identifies credential information; and
a sending module 1202, configured to send the first message.

In an example implementation, the generating module 1201 is configured to generate a second message, where the first message includes credential identification information that identifies credential information; and
the sending module 1202 is configured to send the first message.

In an example implementation, each of the at least one credential includes a certificate, where the certificate includes a public key.

In an example implementation, the credential identification information includes a pointer or a uniform resource locator to the credential information.

In an example implementation, the first message includes a signed message and a second message, and the signed message includes one or more signatures on the second message, where the second message includes the credential identification information.

In an example implementation, the second message further includes a basic safety message.

In an example implementation, the one or more signatures on the second message are obtained by using one or more signature algorithms with one or more private keys.

In an example implementation, the generating module 1201 is further configured to: generate the second message including the credential identification information; and
sign the second message with the one or more private keys by using the one or more signature algorithms.

In an example implementation, the one or more signature algorithms respectively correspond to one or more credentials.

In an example implementation, the one or more signature algorithms includes at least one of: at least one first signature algorithm, or at least one second signature algorithm.

In an example implementation, the one or more signatures include at least one of: at least one first signature obtained by using at least one first signature algorithm, or at least one second signature obtained by using at least one second signature algorithm.

In an example implementation, the one or more signatures include a first signature and a second signature, and the at least one credential includes a first credential corresponding to a first signature algorithm used to obtain the first signature and a second credential corresponding to a second signature algorithm used to obtain the second signature.

In an example implementation, the one or more signatures include a first signature and a second signature, the first message further includes a first credential corresponding to a first signature algorithm used to obtain the first signature, and the at least one credential includes a second credential corresponding to a second signature algorithm used to obtain the second signature.

In an example implementation, the one or more signatures include a first signature, and the at least one credential includes a first credential corresponding to a first signature algorithm used to obtain the first signature; or the one or more signatures include one or more second signatures, and the at least one credential includes one or more second credentials corresponding to one or more second signature algorithms used to obtain the one or more second signatures.

In an example implementation, the first signature algorithm is a non-post-quantum cryptography (non-PQC) algorithm.

In an example implementation, the second signature algorithm is a post-quantum cryptography (PQC) algorithm

In an example implementation, the first apparatus 1200 further includes:
an obtaining module 1203, configured to obtain the at least one credential.

In an example implementation, the first apparatus 1200 further includes:
a registering module 1204, configured to perform registration to obtain the credential identification information.

In an example implementation, the registering module 1204 is further configured to:
send the credential information; and
obtain the credential identification information.

In an example implementation, the first message is sent in a broadcast mode.

It should be understood by a person skilled in the art that, the relevant description of the above modules in the embodiments of the present disclosure may be understood with reference to the relevant description of the communication method in the embodiments of the present disclosure.

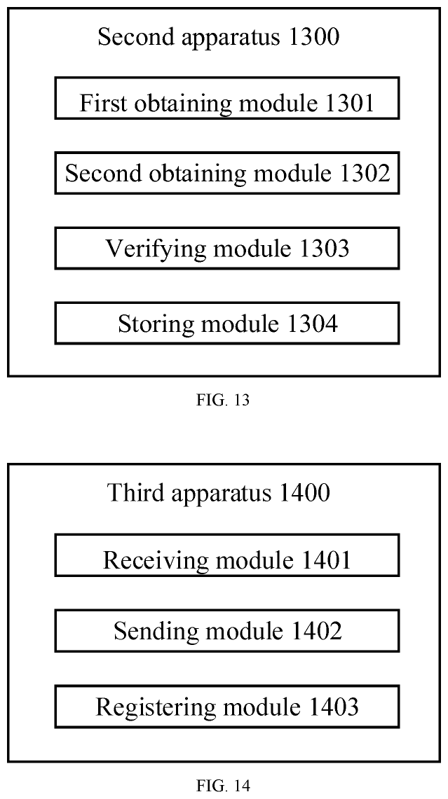

FIG. 13 shows a schematic structural diagram of a second apparatus according to one or more example embodiments of the present disclosure. The second apparatus may be applied to the receiving device described above, or installed in or applied to a chip in the receiving device or any other equipment, module, circuit or unit that can implement the steps of the receiving device in above method embodiments. As shown in FIG. 13, a second apparatus 1300 may include:
a first obtaining module 1301, configured to obtain a first message, where the first message includes credential identification information that identifies credential information;
a second obtaining module 1302, configured to obtain the credential information according to the credential identification information; and obtain one or more credentials, where at least one of the one or more credentials is obtained from the credential information; and
a verifying module 1303, configured to verify the first message according to the one or more credential.

In an example implementation, the credential identification information includes a pointer or a uniform resource locator to the credential information.

In an example implementation, the first obtaining module 1301 is further configured to:
obtain the credential identification information according to the credential identification from a server.

In an example implementation, the first obtaining module 1301 is further configured to:
send the credential identification information to the server; and
receive the credential information identified by the credential identification information from the server.

In an example implementation, the second apparatus 1300 further includes:
a storing module 1304, configured to store the credential information identified by the credential identification information locally.

In an example implementation, the credential identification information is obtained according to the credential identification from a server in a case that the credential identification information is not stored locally.

In an example implementation, the first message includes a signed message and a second message, and the signed message includes one or more signatures on the second message, where the second message includes the credential identification information.

In an example implementation, the second message further includes a basic safety message.

In an example implementation, the one or more signatures are obtained by using one or more signature algorithms, and each of the one or more signatures is obtained by using one of one or more signature algorithms.

In an example implementation, the one or more credentials respectively correspond to the one or more signature algorithms.

In an example implementation, the one or more signatures include at least one of: at least one first signature obtained by using at least one first signature algorithm, or at least one second signature obtained by using at least one second signature algorithm.

In an example implementation, the second obtaining module 1302 is further configured to:
obtain the one or more credentials from the credential information.

In an example implementation, the one or more signatures include a first signature and a second signature, and the first message further includes a first credential corresponding to a first signature algorithm used to obtain the first signature, and the second obtaining module 1302 is further configured to:
obtain the first credential from the first message; and
obtain a second credential corresponding to a second signature algorithm used to obtain the second signature from the credential information.

In an example implementation, the verifying module 1303 is further configured to:
verify, according to the one or more credentials, legitimacy of the second message by using the one or more signature algorithms.

In an example implementation, the one or more credentials include one or more public keys respectively corresponding to the one or more signature algorithms, and the verifying module 1303 is configured to:
verify the one or more signatures by using the one or more signature algorithm with the one or more public keys.

In an example implementation, the one or more credential includes one or more certificate respectively corresponding to the one or more signature algorithms, and the verifying module 1303 is further configured to:
verify the one or more certificates.

In an example implementation, the first signature algorithm is a non-post-quantum cryptography (non-PQC) algorithm.

In an example implementation, the second signature algorithm is a post-quantum cryptography (PQC) algorithm.

In an example implementation, the first message is a broadcast message.

It should be understood by a person skilled in the art that, the relevant description of the above modules in the embodiments of the present disclosure may be understood with reference to the relevant description of the data processing method in the embodiments of the present disclosure.

FIG. 14 shows a schematic structural diagram of a third apparatus according to one or more example embodiments of the present disclosure. The third apparatus may be applied to the server described above, or installed in or applied to a chip in the server or any other equipment, module, circuit or unit that can implement the steps of the server in above method embodiments. As shown in FIG. 14, a second apparatus 1400 may include:
a receiving module 1401, configured to receive, from second user equipment (UE), credential identification information, where the credential identification information identifies credential information of first UE; and
a sending module 1402, configured to send, to the second UE, the credential information of the first UE identified by the credential identification information.

In an example implementation, the credential information of the first UE includes at least one credential of the first UE.

In an example implementation, each of the at least one credential includes a certificate, the certificate includes a public key.

In an example implementation, the third apparatus 1400 further includes:
a registering module 1403, configured to perform registration for the first UE.

In an example implementation, the registering module 1403 is configured to:
receive the credential information of the first UE;
store the credential information of the first UE, and generate the credential identification information that identifies the credential information of the first UE; and
send the credential identification information.

In an example implementation, the at least one credential corresponds to at least one signature algorithm respectively.

In an example implementation, the credential information includes at least one of: at least one first credential corresponding to at least one first signature algorithm, and at least one second credential corresponding to at least one second signature algorithm.

In an example implementation, the first signature algorithm is a non-post-quantum cryptography (non-PQC) algorithm.

In an example implementation, the second signature algorithm is a post-quantum cryptography (PQC) algorithm.

It should be understood by a person skilled in the art that, the relevant description of the above modules in the embodiments of the present disclosure may be understood with reference to the relevant description of the data processing method in the embodiments of the present disclosure.

An embodiment of the present disclosure provides a fourth apparatus including processing circuitry for executing any of the above communication methods performed by the transmitting device. It should be understood that the fourth apparatus can execute the steps performed by the transmitting device in the above method embodiments, which will not be repeated here.

An embodiment of the present disclosure provides a fifth apparatus including processing circuitry for executing any of the above communication methods performed by the receiving device. It should be understood that the fifth apparatus can execute the steps performed by the receiving device in the above method embodiments, which will not be repeated here.

An embodiment of the present disclosure provides a sixth apparatus including processing circuitry for executing any of the above communication methods performed by the server. It should be understood that the sixth apparatus can execute the steps performed by the server in the above method embodiments, which will not be repeated here.

An embodiment of the present disclosure provides a communication system which includes at least one first apparatus and/or at least one fourth apparatus described above, at least one second apparatus and/or at least one fifth apparatus described above, and at least one third apparatus and/or at least one sixth apparatus described above.

An embodiment of the present disclosure provides a communication system, including at least one first processing circuitry, at least one second processing circuitry and at least one third processing circuitry. The first processing circuitry is configured to execute the steps executed by the transmitting device in any of the above communication methods, and the second processing circuitry is configured to execute the steps executed by the receiving device in any of the above communication methods, the third processing circuitry is configured to execute the steps executed by the server in any of the above communication methods.

An embodiment of the present disclosure provides a computer-readable medium storing computer execution instructions which, when executed by a processor, causes the processor to execute any of the above communication methods.

An embodiment of the present disclosure provides a computer program product including computer execution instructions which, when executed by a processor, causes the processor to execute any of the above communication methods.

Although embodiments of the present disclosure describes methods and processes with steps in a certain order, one or more steps of the methods and processes may be omitted or altered as appropriate. One or more steps may take place in an order other than that in which they are described, as appropriate.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration information, or other data, which, when executed, cause a machine (e.g., a processor or other processing device) to perform steps in a method according to examples of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may include a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

Although embodiments have been described above with reference to the accompanying drawings, those of skill in the art will appreciate that variations and modifications may be made without departing from the scope thereof as defined by the appended claims.

1. A communication method, comprising:
obtaining a first message, wherein the first message comprises credential identification information that identifies credential information;
obtaining the credential information according to the credential identification information;
obtaining one or more credentials, wherein at least one of the one or more credentials is obtained from the credential information; and
verifying the first message according to the one or more credentials.

2. The communication method according to claim 1, wherein the credential identification information comprises a pointer or a uniform resource locator to the credential information.

3. The communication method according to claim 1, wherein the first message comprises a signed message and a second message, and the signed message comprises one or more signatures on the second message, wherein the second message comprises the credential identification information.

4. The communication method according to claim 3, wherein the second message further comprises a basic safety message.

5. The communication method according to claim 3, wherein each of the one or more signatures is obtained by using one of the one or more signature algorithms.

6. The communication method according to claim 1, wherein obtaining the credential information according to the credential identification information comprises obtaining the credential information from a server according to the credential identification information.

7. The communication method according to claim 6, wherein obtaining the credential information from the server comprises:
sending the credential identification information to the server; and
receiving, from the server, the credential information identified by the credential identification information.

8. The communication method according to claim 1, further comprising storing the credential information identified by the credential identification information locally.

9. The communication method according to claim 8, wherein the credential information is obtained from a server according to the credential identification information in a case that the credential information identified by the credential identification information is not stored locally.

10. The communication method according to claim 5, wherein the one or more credentials respectively correspond to the one or more signature algorithms.

11. The communication method according to claim 1, wherein obtaining the one or more credentials comprises obtaining the one or more credentials from the credential information.

12. The communication method according to claim 5, wherein the one or more signatures comprise a first signature and a second signature, the first message further comprises a first credential corresponding to a first signature algorithm used to obtain the first signature, and obtaining the one or more credentials comprises:
obtaining the first credential from the first message; and
obtaining a second credential corresponding to a second signature algorithm used to obtain the second signature from the credential information.

13. The communication method according to claim 5, wherein verifying the first message according to the one or more credentials comprises verifying, according to the one or more credentials, legitimacy of the second message by using the one or more signature algorithms.

14. The communication method according to claim 13, wherein the one or more credentials comprise one or more public keys respectively corresponding to the one or more signature algorithms, and verifying, according to the one or more credentials, the legitimacy of the second message by using the one or more signature algorithms comprises verifying the one or more signatures by using the one or more signature algorithms with the one or more public keys.

15. An apparatus, comprising:
one or more processors; and
a memory storing instructions that, when executed by the one or more processors, cause the apparatus to:
obtain a first message, wherein the first message comprises credential identification information that identifies credential information;
obtain the credential information according to the credential identification information;
obtain one or more credentials, wherein at least one of the one or more credentials is obtained from the credential information; and
verify the first message according to the one or more credentials.

16. The apparatus according to claim 1, wherein the credential identification information comprises a pointer or a uniform resource locator to the credential information.

17. The apparatus according to claim 1, wherein the first message comprises a signed message and a second message, and the signed message comprises one or more signatures on the second message, wherein the second message comprises the credential identification information.

18. The apparatus according to claim 17, wherein the second message further comprises a basic safety message.

19. The apparatus according to claim 17, wherein each of the one or more signatures is obtained by using one of the one or more signature algorithms.

20. A non-transitory computer-readable storage medium storing instructions that, when executed by one or more processors, cause the one or more processors to:
obtain a first message, wherein the first message comprises credential identification information that identifies credential information;
obtain the credential information according to the credential identification information;
obtain one or more credentials, wherein at least one of the one or more credentials is obtained from the credential information; and
verify the first message according to the one or more credentials.
